(19) United States
(12) Patent Application Publication
(10) Pub. No.: US 2025/0330593 A1
(43) Pub. Date: Oct. 23, 2025

(54) VIDEO DECODING METHOD, VIDEO ENCODING METHOD, DECODER, ENCODER AND COMPUTER-READABLE STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(21) Appl. No.: 19/259,475

(22) Filed: Jul. 3, 2025

Related U.S. Application Data
(63) Continuation of application No. PCT/CN2023/070554, filed on Jan. 4, 2023.

(51) Int. Cl. H04N 19/11; H04N 19/105; H04N 19/174; H04N 19/176; H04N 19/70

(52) U.S. Cl. CPC H04N 19/11; H04N 19/105; H04N 19/174; H04N 19/176; H04N 19/70

(57) ABSTRACT

Provided in the embodiments of the present application are a video decoding method, a video encoding method, a decoder, an encoder and a computer-readable storage medium. The video decoding method comprises: parsing a bitstream to determine a first intra prediction flag corresponding to a current block; determining, according to prediction modes corresponding to one or more positions neighboring to the current block, M candidate prediction modes corresponding to the first intra prediction flag, wherein M is a positive integer; constructing an intra prediction mode list based on the M candidate prediction modes, and performing intra prediction on the current block based on the intra prediction mode list, to determine a prediction block of the current block; determining a reconstructed block of the current block based on the prediction block of the current block.

### CROSS-REFERENCE TO RELATED APPLICATIONS

This application is a continuation of International Application No. PCT/CN2023/070554, filed on Jan. 4, 2023, the disclosure of which is hereby incorporated by reference in its entirety.

### TECHNICAL FIELD

Embodiments of this application relate to a video coding technology, and relate to but are not limited to a video encoding/decoding method, a decoder, an encoder, and a computer readable storage medium.

### BACKGROUND

Generally, the intra prediction performs prediction on a current coding block to obtain prediction blocks according to various angular prediction modes and non-angular prediction modes, calculates rate-distortion information according to the prediction blocks and the original block, and selects an optimal prediction mode for the current coding block from the various angular prediction modes and non-angular prediction modes, and transmits the prediction mode to the decoding side via the bitstream. The decoding side parses the prediction mode, predicts the prediction picture of the current decoding block, and adds it with residual pixels transmitted by the bitstream to obtain the reconstructed picture. In some intra prediction technologies, a candidate prediction mode list is constructed using various angular prediction modes and non-angular prediction modes to select the optimal prediction mode according to the candidate prediction mode list. However, in a current video coding, different intra prediction technologies use different processes to construct a candidate prediction mode list, resulting in complexity of coding, and thus reducing efficiency and performance of coding.

### SUMMARY

Embodiments of this application provide a video encoding/decoding method, a decoder, an encoder, and a computer readable storage medium, which can improve coding efficiency, thereby improving coding performance.

According to a first aspect, an embodiment of this application provides a video decoding method, where the method includes:
parsing a bitstream to determine a first intra prediction flag corresponding to a current block;
determining, according to prediction modes corresponding to prediction blocks in at least five positions neighboring to the current block, M candidate prediction modes corresponding to the first intra prediction flag, wherein M is a positive integer; and
constructing an intra prediction mode list based on the M candidate prediction modes, and
performing intra prediction and picture reconstruction on the current block based on the intra prediction mode list to determine a reconstructed picture block corresponding to the current block.

According to a second aspect, an embodiment of this application further provides a video encoding method, and the method includes:
determining M candidate prediction modes corresponding to a first intra prediction flag according to prediction modes corresponding to prediction blocks in at least five positions neighboring to a current block, wherein M is a positive integer;
constructing an intra prediction mode list based on the M candidate prediction modes, and performing intra prediction on the current block based on the intra prediction mode list, to determine prediction picture blocks corresponding to the current block.

According to a third aspect, an embodiment of this application provides a decoder, including:
a parsing part, configured to parse a bitstream to determine a first intra prediction flag corresponding to a current block;
a first determining part, configured to determine, according to prediction modes corresponding to prediction blocks in at least five positions neighboring to the current block, M candidate prediction modes corresponding to the first intra prediction flag, wherein M is a positive integer;
a first constructing part, configured to construct an intra prediction mode list based on the M candidate prediction modes; and
a prediction and reconstruction part, configured to perform intra prediction and picture reconstruction on the current block based on the intra prediction mode list to determine a reconstructed picture block corresponding to the current block.

According to a fourth aspect, an embodiment of this application provides an encoder, including:
a second determining part, configured to determine M candidate prediction modes corresponding to a first intra prediction flag according to prediction modes corresponding to prediction blocks in at least five positions neighboring to a current block, wherein M is a positive integer;
a second constructing part, configured to construct an intra prediction mode list based on the M candidate prediction modes; and
a prediction part, configured to perform intra prediction on the current block based on the intra prediction mode list, to determine prediction picture blocks corresponding to the current block.

According to a fifth aspect, an embodiment of this application further provides a decoder, including:
a first memory, configured to store an executable instruction;
a first processor, configured to implement the video decoding method in an embodiment of this application when executing the executable instruction stored in the first memory.

According to a sixth aspect, an embodiment of this application further provides an encoder, including:
a second memory, configured to store an executable instruction;
a second processor, configured to implement the video encoding method in an embodiment of this application when executing the executable instruction stored in the first memory.

An embodiment of this application provides a bitstream, the bitstream is generated by performing bit encoding according to to-be-encode information; wherein the to-be-encode information includes: a first intra prediction flag and an encoded bit obtained by encoding a current block by a first prediction mode; and the first prediction mode is determined by:
determining M candidate prediction modes corresponding to the first intra prediction flag according to prediction modes corresponding to prediction blocks in at least five positions neighboring to a current block, wherein M is a positive integer;
constructing an intra prediction mode list based on the M candidate prediction modes, and performing intra prediction on the current block based on the intra prediction mode list, to determine prediction picture blocks corresponding to the current block; and
determining the first prediction mode from the M candidate prediction modes according to the current block and the prediction picture blocks.

An embodiment of this application provides a computer readable storage medium, and a computer program is stored on the computer readable storage medium. When the computer program is executed by a first processor, a video decoding method provided in an embodiment of this application is implemented. Alternatively, when the computer program is executed by a second processor, a video encoding method provided in an embodiment of this application is implemented.

### BRIEF DESCRIPTION OF DRAWINGS

FIG. 1 is a schematic diagram of 1-67 conventional intra prediction mode angles.

FIG. 2 is a schematic diagram of a block diagram of an encoder according to an embodiment of this application.

FIG. 3 is a schematic diagram of a block diagram of a decoder according to an embodiment of this application.

FIG. 4 is a schematic diagram of a network architecture of a coding system according to an embodiment of this application.

FIG. 5 is an optional schematic flowchart of a decoding method according to an embodiment of this application.

FIG. 6 is an optional schematic diagram of a prediction block at an adjacent position of a current block according to an embodiment of this application.

FIG. 7 is an optional schematic diagram of a prediction block at an adjacent position of a current block according to an embodiment of this application.

FIG. 8 is an optional schematic diagram of a prediction block at an adjacent position of a current block according to an embodiment of this application.

FIG. 9 is an optional schematic flowchart of a decoding method according to an embodiment of this application.

FIG. 10 is a schematic diagram of 64 geometric partitioning modes according to an embodiment of this application.

FIG. 11 is a schematic diagram of a template area used in a template-based intra mode derivation technology and reference lines used to generate a prediction value according to an embodiment of this application.

FIG. 12 is a schematic diagram of steps of deriving an intra prediction mode by a decoder-side intra mode derivation mode according to an embodiment of this application.

FIG. 13 is a schematic diagram of four rows of reference pixels around a current block used in a multiple reference line intra prediction technology according to an embodiment of this application.

FIG. 14 is a schematic diagram of templates and reference lines around a current block in a template-based multiple reference line intra prediction technology according to an embodiment of this application.

FIG. 15 is an optional schematic flowchart of a decoding method according to an embodiment of this application.

FIG. 16 is a schematic diagram of a correspondence between a candidate angular prediction mode of a first precision and an extended candidate angular prediction mode of a second precision according to an embodiment of this application.

FIG. 17 is a schematic diagram of matching a conventional prediction mode to an extended angular prediction mode according to an embodiment of this application.

FIG. 18 is a schematic diagram of mode extension of performing −1 and +1 on an extended angular prediction mode ipmExt according to an embodiment of this application.

FIG. 19 is a schematic diagram of a process of selecting N candidate prediction modes based on extended angular prediction modes according to an embodiment of this application.

FIG. 20 is an optional schematic flowchart of an encoding method according to an embodiment of this application.

FIG. 21 is a first schematic structural diagram of a decoder according to an embodiment of this application.

FIG. 22 is a second schematic structural diagram of a decoder according to an embodiment of this application.

FIG. 23 is a first schematic structural diagram of an encoder according to an embodiment of this application.

FIG. 24 is a second schematic structural diagram of an encoder according to an embodiment of this application.

### DESCRIPTION OF EMBODIMENTS

The following clearly and completely describes the technical solutions in the embodiments of this application with reference to the accompanying drawings in the embodiments of this application. It may be understood that a specific embodiment described herein is merely used to explain the application, but is not a limitation on the application. In addition, for ease of description, only a part related to the related application is shown in the accompanying drawings.

It should be noted that the “first”, “second”, “third” and the like mentioned throughout the specification are merely intended to distinguish different features, and do not limit a priority, a sequence, or a size relationship.

The terms involved in the embodiments of this application are applied to the following explanations:
1) ECM. EMC is reference software based on the VTM-10.0. ECM integrates various new tools to further improve the decoding performance.
2) Decoder-side intra mode derivation (Decoder-side intra mode derivation, DIMD)
3) Template-based intra mode derivation (Template-based intra mode derivation, TIMD)
4) Most probable modes (intra) (Most probable modes, MPM)
5) Second most probable mode (intra) (Secondary MPM, SMPM)
6) multiple reference line intra prediction (Multiple reference line (MRL) intra prediction, MRL)
7) Template-based multiple reference line intra prediction (Template-based multiple reference line intra prediction, TMRL)
8) Geometric partitioning mode (Geometric partitioning mode, GPM)
9) Spatial geometric partitioning mode (Spatial geometric partitioning mode, SGPM)
10) Matrix weighted intra prediction (Matrix weighted intra prediction, MIP)
11) intra template matching prediction (intra template matching prediction, intra TMP)

The digital video compression technology mainly used to compress massive digital video data, so as to facilitate transmission, storage, and the like. With a surge in Internet video and a growing demand for video clarity, although existing digital video compression standards can reduce a large amount of video data, a better digital video compression technology is still needed, so as to reduce bandwidth and traffic pressure of digital video transmission.

Video compression includes multiple modules, such as intra prediction (space domain) and inter prediction (time domain) for reducing or removing inherent redundancy of the video, transform and quantization of residual information, and reverse quantization and reverse transform, inter-loop filter and entropy coding for improving subjective and objective reconstruction quality. Most mainstream video compression standards describe compression technologies based on blocks. A video film, a frame of pictures or a series of pictures are divided into basic units of CTUs, and are further divided into block units of CUs. An intra block is predicted by using pixels around the block as reference, and an inter block refers to adjacent block information in the reference space and reference information in other frames. In contrast to a prediction signal, residual information is converted into bitstream by transform, quantization and entropy coding in the unit of block. These techniques are described in the standards and implemented in various areas related to video compression. Internationally, the mainstream standards include H.264/Advanced Video Coding (AVC), H.265/High Efficiency Video Coding (HEVC) standard, H.266/Versatile Video Coding (VVC), the expansion of these standards, and the like. A video device may implement these technologies to achieve more efficient video coding, transmission and storage.

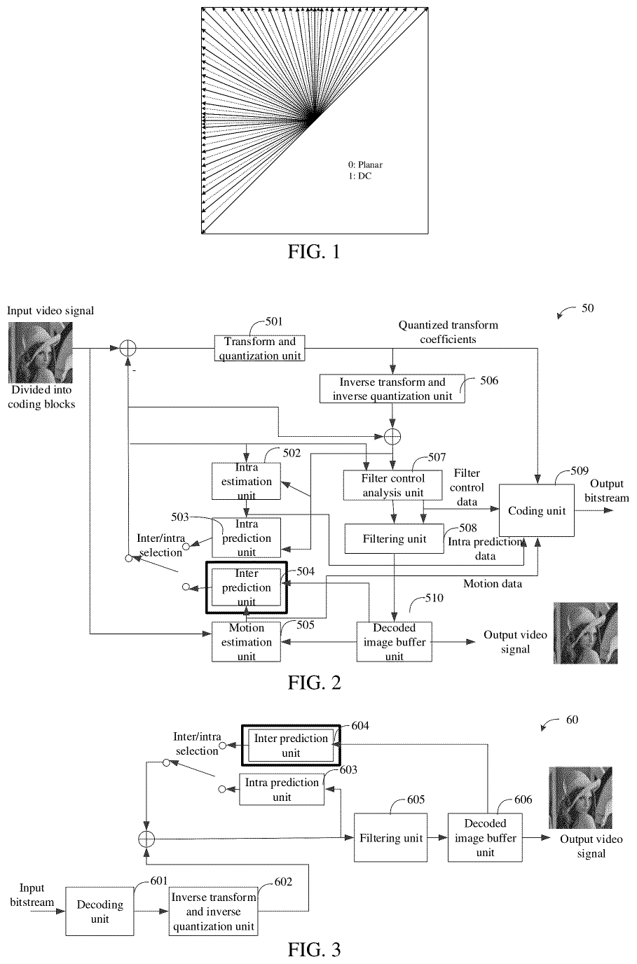

Generally, the intra prediction process performs prediction on the current coding block by using various angular prediction modes and non-angular prediction modes to obtain prediction blocks. According to rate-distortion information obtained by means of calculation on the prediction blocks and the original block, an optimal prediction mode of the current coding unit is selected, and then the prediction mode is transmitted to the decoding side via the bitstream. The decoding side parses the prediction mode, predicts the prediction picture of the current decoding block, and adds it to the residual pixels transmitted by the bitstream to obtain the reconstructed picture. In the development of the digital video coding standard, the non-angular prediction mode is relatively stable, including the DC mode and planar mode. The angular prediction mode increases with the evolution of the digital video coding standard. Taking the international digital video coding standard H series as an example, in the 264/AVC standard, there are only eight traditional angular prediction modes and one traditional non-angular prediction mode. The H.265/HEVC extends to 33 traditional angular prediction modes and 2 traditional non-angular prediction modes. In the 266/VVC, conventional intra prediction modes include a Planar mode, a DC mode, and 65 angular prediction modes, as shown in FIG. 1.

Currently, the MPM, the TMRL, and the TIMD need to refer to the prediction modes selected by the prediction blocks around the current block when constructing the intra candidate prediction mode list. However, methods for constructing the intra candidate prediction mode list are different. Therefore, to support various methods for constructing an intra candidate prediction mode list, complexity of software and hardware is increased, and decoding efficiency is reduced.

In addition, currently, when multiple reference line prediction is used in the TIMD mode, intra modes and reference lines selected by TIMD may be potentially duplicated with those selected by TMRL. In this way, code words may be wasted, and decoding efficiency is reduced.

In addition, in the current TMRL mode, only 65 angular prediction modes are supported. The small number of supported angular prediction modes leads to a low prediction accuracy, thereby reducing decode accuracy.

In conclusion, currently, coding efficiency and accuracy of the intra prediction process are low, thereby reducing coding performance.

Embodiments of this application provide a video encoding/decoding method, a decoder, an encoder, and a computer readable storage medium, which can improve performance of the video coding. The following describes the embodiments of this application in detail with reference to the accompanying drawings.

FIG. 2 shows a schematic block diagram of an encoder according to an embodiment of this application. As shown in FIG. 2, an encoder (specifically “video encoder”) 50 may include a transform and quantization unit 501, an intra estimation unit 502, an intra prediction unit 503, an inter prediction unit 504, a motion estimation unit 505, an inverse transform and inverse quantization unit 506, a filter control analysis unit 507, a filtering unit 508, a coding unit 509, a decoded picture buffer unit 510, and the like. The filtering unit 508 may implement de-block filtering and sample adaptive offset (Sample Adaptive offset, SAO) filtering. The coding unit 509 may implement header information coding and context-based adaptive binary arithmetic coding (Context-based Adaptive Binary Arithmetic Coding, CABAC). For an input original video signal, a video coding block may be obtained by means of coding tree units (Coding Tree Unit, CTU) partitioning, and then pixel information obtained after intra or inter prediction is transformed by using a transform and a quantization unit 501. The transform includes converting residual information from a pixel field to a transform field, and quantizing obtained transform coefficients, so as to further reduce a bit rate. The intra estimation unit 502 and the intra prediction unit 503 are configured to perform intra prediction on the video coding block. Specifically, the intra estimation units 502 and intra prediction unit 503 are configured to determine an intra prediction to be used for encoding the video coding block. The inter prediction unit 504 and the motion estimation unit 505 are configured to execute inter prediction encoding on the received video coding block relative to one or more blocks in one or more reference frames to provide time prediction information. The motion estimation executed by the motion estimation unit 505 is a process of generating a motion vector, and the motion vector may be used to estimate a motion of the video coding block, and then the inter prediction unit 504 executes motion compensation based on the motion vector determined by the motion estimation unit 505. Therefore, the inter prediction unit 504 may also be referred to as a motion compensation unit. After determining the intra prediction mode, the intra prediction unit 503 is further configured to provide the selected intra prediction data to the coding unit 509, and the motion estimation unit 505 also sends the calculated motion vector data to the coding unit 509. In addition, the inverse transform and inverse quantization unit 506 is used to reconstruct the video coding block, which reconstructs the residual block in the pixel domain. The reconstructed residual block is processed by the filter control analysis unit 507 and the filter unit 508 to remove the block effect artifact, and then is added to a prediction block in a frame stored in the decoded picture buffer unit 510 to generate the reconstructed video coding block. The coding unit 509 is used to encode various encode parameters and quantized transform coefficients. In the CABAC-based encoding algorithm, context content may be based on adjacent coding blocks, and used to coding an indication of the determined intra prediction mode, to output the a bitstream of the video signal. The decoded picture buffer unit 510 is configured to store the reconstructed video coding block, to be used for prediction reference. As the video picture encoding progresses, new reconstructed video coding blocks are continuously generated, and these reconstructed video coding blocks are stored in the decoded picture cache unit 510.

FIG. 3 shows a schematic diagram of a decoder according to an embodiment of this application. As shown in FIG. 3, a decoder (specifically “video decoder”) 60 includes a decoding unit 601, an inverse transform and inverse quantization unit 602, an intra prediction unit 603, an inter prediction unit 604, a filtering unit 605, a decoded picture buffer unit 606, and the like. The decoding unit 601 may implement header information decoding and CABAC decoding, and the filtering unit 605 may implement de-block filtering and SAO filtering. After the input video signal is processed by using the encoder in FIG. 2, a bitstream of the video signal is output. The bitstream is inputted to the decoder 60. Firstly, the bitstream is processed by the decoding unit 601 to obtain decoded transform coefficients. The transform coefficients are processed by the inverse transform and inverse quantization unit 602, so as to generate a residual block in the pixel domain. The intra prediction unit 603 may be configured to generate prediction data of the current video decoding block based on the determined intra prediction mode and previously decoded block data from the current frame or picture. The inter prediction unit 604 determines prediction information for the video decoding block by parsing the motion vector and other associated syntax element, and uses the prediction information to generate prediction block for the video decoding block being decoded. The decoded video block is formed by summing the residual block from the inverse transform and inverse quantization unit 602 and the corresponding prediction block generated by the intra prediction unit 603 or the inter prediction unit 604. A decoded video signal passes through the filtering unit 605, so as to remove a block effect artifact, thereby improving video quality. Then, the decoded video block is stored in the decoded picture buffer unit 606. The decode picture buffer unit 606 stores a reference picture that is used for subsequent intra prediction or motion compensation, and is also used for output of the video signal, to obtain the recovered original video signal.

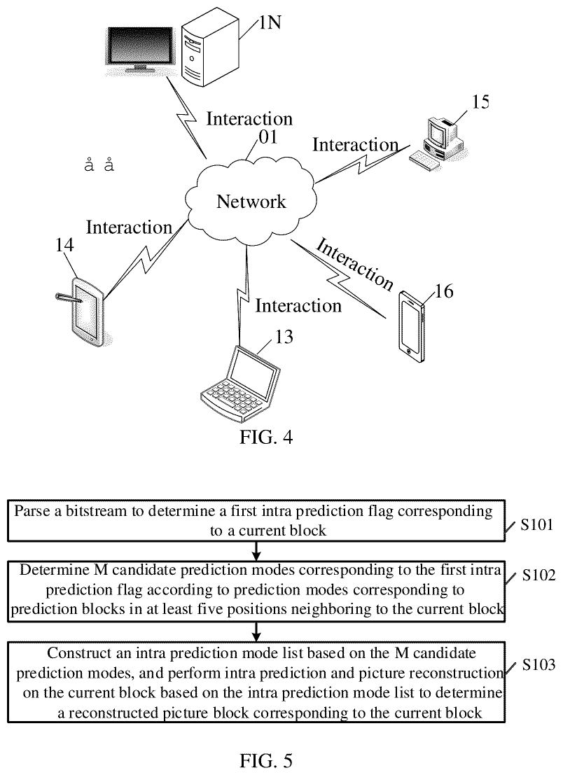

Further, an embodiment of this application further provides network architecture of a coding system that includes an encoder and a decoder. FIG. 4 is a schematic diagram of network architecture of a coding system according to an embodiment of this application. As shown in FIG. 4, the network architecture includes one or more electronic devices 13 to 1N and a communications network 01, where the electronic devices 13 to 1N may perform video interaction by using the communications network 01. In an implementation, the electronic devices may be various types of devices having a video coding function. For example, the electronic device may include a smartphone, a tablet computer, a personal computer, a personal digital assistant, a navigator, a digital telephone, a video telephone, a television, a sensing device, and a server. This is not specifically limited in this embodiment of this application. Herein, the decoder or the encoder described in this embodiment of this application may be any of the foregoing electronic devices.

It should be noted that the method in this embodiment of this application is mainly applied to the intra prediction unit 503 shown in FIG. 2 and the intra prediction unit 603 shown in FIG. 3. That is, this embodiment of this application may be applied to the encoder, may be applied to the decoder, and may even be applied to both the encoder and the decoder. However, this embodiment of this application sets no specific limitation thereto.

It should be further noted that, when applied to the intra prediction unit 503, a “current block” specifically refers to a current coding block on which the intra prediction is to be performed; and when applied to the intra prediction unit 504, a “current block” specifically refers to a current decoding block on which the intra prediction is to be performed.

In an embodiment of this application, FIG. 5 shows a schematic flowchart of a decoding method according to an embodiment of this application. The method may include the following steps.

S101. Parse a bitstream to determine a first intra prediction flag corresponding to a current block.

In S101, the decoder receives the bitstream sent by the encoder, and obtains the current block in the bitstream by parsing the bitstream.

In some embodiments, the current block may be a current coding unit (Coding Unit, CU), a current transform unit (Transform Unit, TU), a current prediction unit (Prediction Unit, PU), a current coding block (Coding Block, CB), or the like, which is not specifically limited in this embodiment of this application.

In this embodiment of this application, the first intra prediction flag is used to represent an intra prediction technology corresponding to the current block. In some embodiments, the first intra prediction flag may include a multiple reference line intra prediction flag. For example, the first intra prediction flag may include any one of: a template-based multiple reference line intra prediction flag (TMRL related flag), a most probable intra prediction flag (MPM related flag), and a template-based intra mode derivation flag (TIMD related flag).

In some embodiments, the decoder may determine the first intra prediction flag by parsing an MRL tool-related syntax element in the bitstream. For example, the decoder may parse a flag bit of cu_tmrl_flag in the bitstream. Herein, the cu_tmrl_flag being 1 represents that the first intra prediction flag is a template-based multiple reference line prediction mode, that is, an intra prediction type of a luma sample corresponding to the current block is a template-based multiple reference line prediction mode. The cu_tmrl_flag being 0 represents that the first intra prediction flag is not the template-based multiple reference line prediction mode. For example, the intra prediction may be performed in a manner of combining an intra prediction mode derived by TIMD with a non-adjacent reference line of the MRL.

S102. Determine M candidate prediction modes corresponding to the first intra prediction flag according to prediction modes corresponding to prediction blocks in at least five positions neighboring to the current block.

In this embodiment of this application, the prediction blocks neighboring to the current block generally have a relatively strong correlation with the current block. Therefore, intra prediction modes of the neighboring prediction block has a relatively large probability of being the same or similar to an intra prediction mode corresponding to the current block. In some embodiments, the decoder may determine prediction modes corresponding to prediction blocks in at least five positions neighboring to the current block, so as to determine M candidate prediction modes according to the prediction modes corresponding to the prediction blocks in the at least five positions. Herein, a range that may be neighboring to the current block may include a neighboring area that is rebuilt around the current block and that is used to provide reference information for the intra prediction mode of the current block. For example, the neighboring area may include an area within a preset distance to the current block. The prediction blocks are reconstructed picture blocks in neighboring positions to the current block.

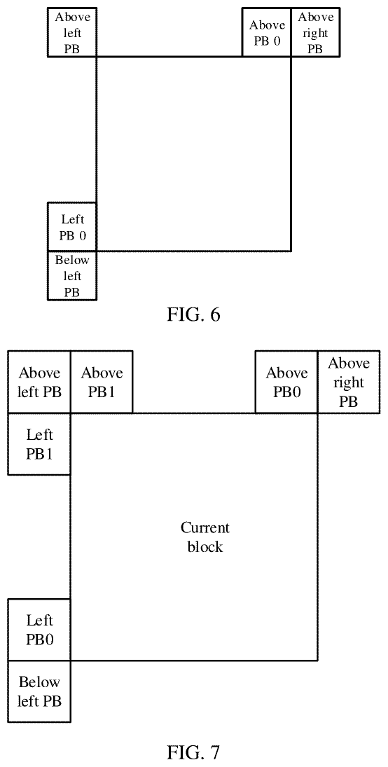

In some embodiments, the decoder may determine prediction modes corresponding to prediction blocks in five positions neighboring to the current block. For example, the coordinates (0,0) in the upper left corner of the current block are used as an example. Five positions neighboring to the current block are respectively above left (−1, −1), above 0 (width−1, −1), above right (width, −1), and left 0 (−1, height−1), and below left (−1, height). The width and height are respectively a width and a height of the current block. For example, the prediction blocks in the foregoing five positions may be as shown in FIG. 6.

In some embodiments, the decoder may determine prediction modes corresponding to prediction blocks in seven positions neighboring to the current block. For example, the coordinates (0, 0) of the upper left corner of the current block are used as an example. The seven positions neighboring to the current block are respectively above left (−1, −1), above 1 (0, −1), above 0 (width−1, −1), above right (width, −1), left 1 (−1, 0), and left 0 (−1, height−1), and below left (−1, height). For example, the prediction blocks in the foregoing seven positions may be as shown in FIG. 7.

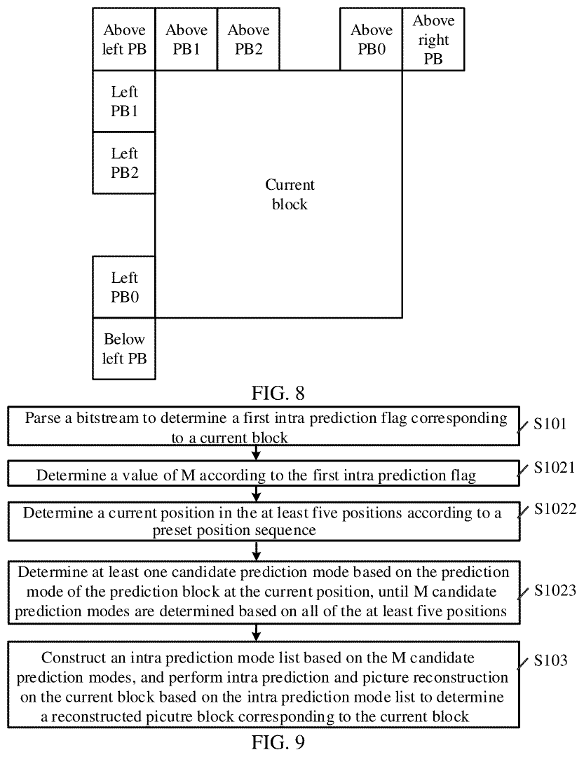

In some embodiments, the decoder may determine prediction modes corresponding to prediction blocks in nine positions neighboring to the current block. For example, the coordinates (0,0) of the upper left corner of the current block are used as an example. The nine positions neighboring to the current block are respectively above left (−1, −1), above 1 (0, −1), above 2 (width/2−1, −1), above 0 (width−1, −1), above right (width, −1), left 1 (−1, 0), left 2 (−1, height/2−1), left 0 (−1, height−1), and below left (−1, height). For example, the prediction blocks in the foregoing nine positions may be as shown in FIG. 8.

In some embodiments, the decoder may determine prediction modes corresponding to prediction blocks in all positions neighboring to the current block. For example, prediction modes corresponding to all prediction blocks within a preset distance range around the current block are determined.

In some embodiments, the decoder may determine prediction modes corresponding to adjacent prediction blocks corresponding to the current block. Herein, the adjacent prediction blocks corresponding to the current block may include prediction blocks that is within a preset distance range and adjacent to a boundary of the current block. FIG. 6 to FIG. 8 show several examples of adjacent prediction blocks corresponding to the current block. In actual application, more prediction blocks may be included, for example, 11 or 13 prediction blocks adjacent to the current block. Specific implementations are selected according to actual situations, which is not limited in this embodiment of this application.

In some embodiments, the decoder may determine a prediction mode corresponding to a non-adjacent prediction block corresponding to the current block. Herein, the non-adjacent prediction block corresponding to the current block may include a prediction block that is within a preset distance range and that is not adjacent to a boundary of the current block. The non-adjacent prediction block is still within a preset distance range corresponding to the current block, and is strongly correlated with the intra prediction mode of the current block. Therefore, a prediction mode of the non-adjacent prediction block may be used as a reference to determine candidate prediction mode information corresponding to the current block.

It should be noted that a quantity of neighboring prediction blocks of the current block may vary because of different sizes of the current block and different surrounding block partitions. Therefore, a case in which only one prediction block exists in two or more positions in the foregoing at least five positions may occur. In this case, the prediction mode corresponding to the prediction blocks may be used as a prediction mode jointly corresponding to the two or more positions, and no additional surrounding prediction block is added.

In this embodiment of this application, M is a positive integer. Based on the foregoing method, the decoder may determine M candidate prediction modes corresponding to the first intra prediction flag according to the prediction modes corresponding to the determined prediction blocks in the at least five positions neighboring to the current block.

In some embodiments, the M candidate prediction modes may be determined based on the prediction modes corresponding to the prediction blocks in the at least five positions in a manner of constructing an MPM list and a Secondary MPM (second MPM) list in the MPM.

For example, the MPM list and the Secondary MPM list are respectively a list whose length is 6 and a list whose length is 16, and the MPM list is filled with candidate intra prediction modes that are most probable to be selected by the current prediction block. For example, the candidate intra prediction modes may be determined according to the intra prediction modes selected by the prediction blocks in the five positions as shown in FIG. 6 and their adjacent intra prediction modes. Herein, the prediction blocks in the five adjacent positions of the current block may also be prediction blocks in other five positions, which are selected according to actual situations, which is not limited in this embodiment of this application. Among the six intra prediction modes in the MPM list, the Planar mode is always listed at the top of the MPM list, and the remaining five intra prediction modes are determined in sequence according to step a) to step c). If there are more than five intra prediction modes, the additional intra prediction modes will automatically enter the Secondary MPM list.
a) Determine five prediction modes selected by five prediction blocks in positions around the current block as candidate intra prediction modes;
b) Determine that a mode derive based on a gradient histogram of reconstructed pixels around the current block as a candidate intra prediction mode; and
c) Determine an angular prediction mode related to the first two angular prediction modes derived in step a) and step b) as a candidate intra prediction mode.

It should be noted that when the candidate intra prediction modes determined by using the foregoing step are insufficient to fill both the MPM list and the Secondary MPM list, intra prediction modes in a preset intra prediction mode list is used as a candidate intra prediction mode, to fill up both the MPM and the Secondary MPM without repetitions, that is, M=22 candidate prediction modes are obtained.

In some embodiments, the preset intra prediction mode list may be a mpm_default[20] list, and includes 20 angular prediction modes: Mpm_default[20]={50, 18, 46, 54, 14, 22, 42, 58, 10, 26, 38, 62, 6, 30, 34, 66, 2, 48, 52, 16}.

In some embodiments, on the basis of the foregoing MPM list and Secondary MPM list construction manners, M candidate prediction modes may be determined by removing a conventional intra prediction mode, such as a Planar mode, a DC mode, a horizontal mode, and a vertical mode, which may be determined according to actual situations, and is not limited in this embodiment of this application.

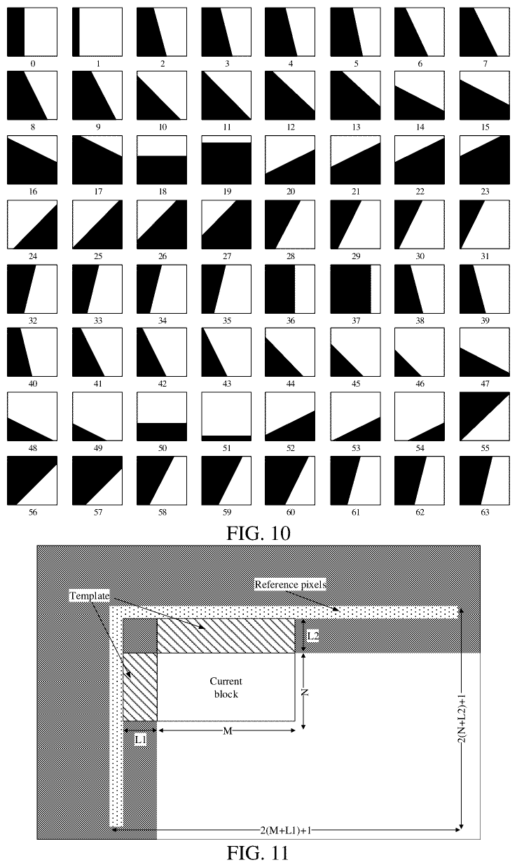

In some embodiments, based on FIG. 5, as shown in FIG. 9, S102 may be implemented by S1021 to S1023 as follows.

S1021. Determine a value of M according to the first intra prediction flag.

In this embodiment of this application, the M candidate prediction modes are equivalent to a to-be-constructed candidate prediction mode list. The candidate prediction mode list to be constructed may have different lengths of using different intra prediction technologies, that is, the quantity of candidate prediction modes may be different. For example, in a case in which the first intra prediction flag represents the MPM, M may be 22. In a case in which the first intra prediction flag represents TMRL, M may be 6.

S1022. Determine a current position in the at least five positions according to a preset position sequence.

In this embodiment of this application, for different indications of the first intra prediction flag, such as MPM or TMRL, the decoder may successively determine, according to a unified preset position sequence, prediction blocks respectively corresponding to the at least five positions, so as to determine the M candidate prediction modes based on prediction modes respectively corresponding to the positions. Herein, the current position is a position determined from the at least five positions according to a preset position sequence, each time when deriving a prediction mode from a prediction block neighboring to the current block.

For example, the decoder may successively derive at least one candidate prediction mode for each prediction block according to a preset position sequence of left prediction block 0, upper prediction block 0, above left prediction block, below left prediction block, and above right prediction block, and determine the M candidate prediction modes based on the candidate prediction modes derived for the prediction blocks in the foregoing five positions and the related candidate prediction mode.

S1023. Determine at least one candidate prediction mode based on the prediction mode of the prediction block at the current position, until M candidate prediction modes are determined based on all of the at least five positions.

In this embodiment of this application, the decoder may derive, based on the prediction mode of the prediction block at the current position, at least one candidate prediction mode corresponding to the prediction block at the current position. The decoder performs derives a candidate prediction mode for the prediction block of each of the at least five positions until M candidate prediction modes are determined.

At present, in ECM, the multiple reference line prediction mode can only be used with five modes other than PLANAR in MPM. In some embodiments of this application, the template-based multiple reference line prediction is not bound to an MPM, but M candidate prediction modes are determined according to prediction modes of prediction blocks in at least five positions around the current block, which is equivalent to constructing a candidate prediction mode list, and a final intra prediction mode is selected from the candidate prediction mode list.

In some embodiments, a process of the S1023 of determining the at least one candidate prediction mode based on the prediction mode of the prediction block at the current position may be implemented by S01 as follows.

S01. In a case that the prediction block at the current position is an intra prediction block, and the prediction mode of the prediction block at the current position is the spatial geometric partitioning mode, determine an angular prediction mode corresponding to a partitioning direction of the prediction block at the current position, as the at least one candidate prediction mode.

In this embodiment of this application, the spatial geometric partitioning mode (SGPM) is an intra partition prediction mode. The SGPM partitions a to-be-predicted intra block into two parts, and the two parts are separately predicted by using different intra prediction modes. SGPM is derived from GPM. GPM is an inter-frame partition prediction mode, which partitions a to-be-predicted inter prediction block into two parts. The two parts may use different intra prediction or inter prediction modes. In ECM, GPM supports 64 partitioning modes, as shown in FIG. 10. In ECM reference software, compared with GPM, SGPM supports 26 different directions or positions among the 64 modes.

A total of 32 partition angles are included in the 64 partitioning modes supported by the GPM, and the 32 partition angles may be corresponding to conventional intra prediction angles as shown in Table 1.

TABLE 1

| angleIdx | 0 | 1 | 2 | 3 | 4 | 5 | 6 | 7 |
|---|---|---|---|---|---|---|---|---|
| intraMode | 50 | 0 | 44 | 41 | 34 | 27 | 0 | 0 |
| angleIdx | 8 | 9 | 10 | 11 | 12 | 13 | 14 | 15 |
| intraMode | 18 | 0 | 0 | 9 | 66 | 59 | 56 | 0 |
| angleIdx | 16 | 17 | 18 | 19 | 20 | 21 | 22 | 23 |
| intraMode | 50 | 0 | 44 | 41 | 34 | 27 | 0 | 0 |
| angleIdx | 24 | 25 | 26 | 27 | 28 | 29 | 30 | 31 |
| intraMode | 18 | 0 | 0 | 9 | 66 | 59 | 56 | 0 |

In Table 1, angleIdx represents 32 partition angles, and intraMode represents indexes of 67 conventional intra prediction modes (the Planar mode, the DC mode, and 65 angular prediction modes).

In this embodiment of this application, when the prediction block at the current position is an intra prediction block and the SGPM mode is selected for the prediction block, an intra prediction angle corresponding to the partitioning direction of the SGPM mode may be determined according to Table 1, and the angular prediction mode is determined as a candidate prediction mode, that is, it is used to fill the candidate prediction mode list.

In some embodiments, a process of the S1023 of determining the at least one candidate prediction mode based on the prediction mode of the prediction block at the current position may be implemented by S02 as follows.

S02. In a case that the prediction block at the current position is an intra prediction block, and the prediction mode of the prediction block at the current position is the spatial geometric partitioning mode, determine two intra prediction modes corresponding to two partitioning blocks corresponding to the prediction block at the current position as the at least one candidate prediction mode.

In this embodiment of this application, when the prediction block at the current position is an intra prediction block and the prediction block is in the SGPM mode, different intra prediction modes selected for the two blocks obtained by the SGPM partition may be used to fill the candidate list.

For example, when the prediction block at the current position is an intra prediction block and the SGPM mode is selected for the prediction block, two prediction parts obtained by the SGPM partition on the prediction block may be determined according to FIG. 10, and intra prediction modes respectively selected for the two prediction parts are determined as the candidate prediction modes, that is, they are used to fill the candidate prediction mode list.

In some embodiments, a process of the S1023 of determining the at least one candidate prediction mode based on the prediction mode of the prediction block at the current position may be implemented by S03 as follows.

S03. In a case that the prediction block at the current position is an inter prediction block, and the prediction mode of the prediction block at the current position is the geometric partitioning mode, determine a angular prediction mode corresponding to a partitioning direction of the prediction block at the current position, as the at least one candidate prediction mode.

In this embodiment of this application, when the prediction block at the current position is an inter prediction block and the GPM mode is selected for the prediction block, an intra prediction angle corresponding to a GPM mode partitioning direction may be determined according to Table 1, and the angular prediction mode is determined as a candidate prediction mode, that is, it is used to fill a candidate prediction mode list.

In some embodiments, a process of the S1023 of determining the at least one candidate prediction mode based on the prediction mode of the prediction block at the current position may be implemented by S04 as follows.

S04. In a case that the prediction block at the current position is an inter prediction block, and the prediction mode of the prediction block at the current position is the geometric partitioning mode, determine two intra prediction modes corresponding to two partitioning blocks corresponding to the prediction block at the current position as the at least one candidate prediction mode.

In this embodiment of this application, when the prediction block at the current position is an inter prediction block and the GPM mode is selected for the prediction block, two prediction parts obtained by the SGPM partition on the prediction block may be determined according to FIG. 10, and intra prediction modes respectively selected for the two prediction parts are determined as the candidate prediction modes, that is, they are used to fill the candidate prediction mode list.

In some embodiments, a process of S1023 of determining the at least one candidate prediction mode based on the prediction mode of the prediction block at the current position may be implemented by S04 as follows.

S04. In a case that the prediction block at the current position is an intra prediction block, and the prediction mode of the prediction block at the current position is the template-based intra mode derivation mode, determine at least one candidate prediction mode according to the at least two prediction modes derived by the template-based intra mode derivation mode.

In this embodiment of this application, the template-based intra mode derivation mode (TIMD) is a technology of deriving one or more conventional intra prediction modes by using information of an intra prediction mode that is derived from pixel values of several reconstructed rows around the block.

In the ECM-7.0 reference software, a maximum of four intra prediction modes can be derived by using the TIMD export method, including a TIMD mode (timdMode), a second TIMD mode (timdSecondaryMode), a TIMD horizontal mode (timdVer), and a TIMD vertical mode (timdHor).

The TIMD can derive an intra prediction mode based on a cost value at a template location. Herein, a sum of absolute transformed difference (Sum of Absolute Transformed Difference, SATD) may be used as the cost value. As shown in FIG. 11, the L2 rows above the current block is an above template, the left L1 column is a left template, and a row of reconstructed pixel values (Reference of the template) outside of the template area is used as reference pixels to make prediction on the template area under a given intra prediction mode. In the template area, the SATD between the predicted result of the given prediction mode and the reconstructed value is a cost. The TIMD mode is a mode with a least total SATD value for the above template and the left template. The second TIMD mode is a mode with a second least total SATD value for the above template and the left template. The TIMD Vertical mode is a mode with the least SATD value on the above template. The TIMD horizontal mode is a mode with the least SATD value on the left template.

In this embodiment of this application, when the prediction block at the current position is an intra prediction block, and TIMD is selected for the prediction block, at least two prediction modes of the four prediction modes derived by the TIMD may be determined as candidate prediction modes corresponding to the prediction block at the current position.

In some embodiments, the foregoing at least two prediction modes include at least two of the following: An intra prediction mode (that is, a TIMD mode) with the least cost value, an intra prediction mode (that is, a second TIMD mode) with the second least cost value, an intra prediction mode in a horizontal direction (that is, a TIMD horizontal mode), and an intra prediction mode (that is, a TIMD vertical mode) in a vertical direction.

In some embodiments, a process of S1023 of determining the at least one candidate prediction mode based on the prediction mode of the prediction block at the current position may be implemented by S05 as follows.

S05. In a case that the prediction block at the current position is an intra prediction block, and the prediction mode of the prediction block at the current position is the decoder-side intra mode derivation mode, determine the at least one candidate prediction mode according to at least three prediction modes derived by the decoder-side intra mode derivation.

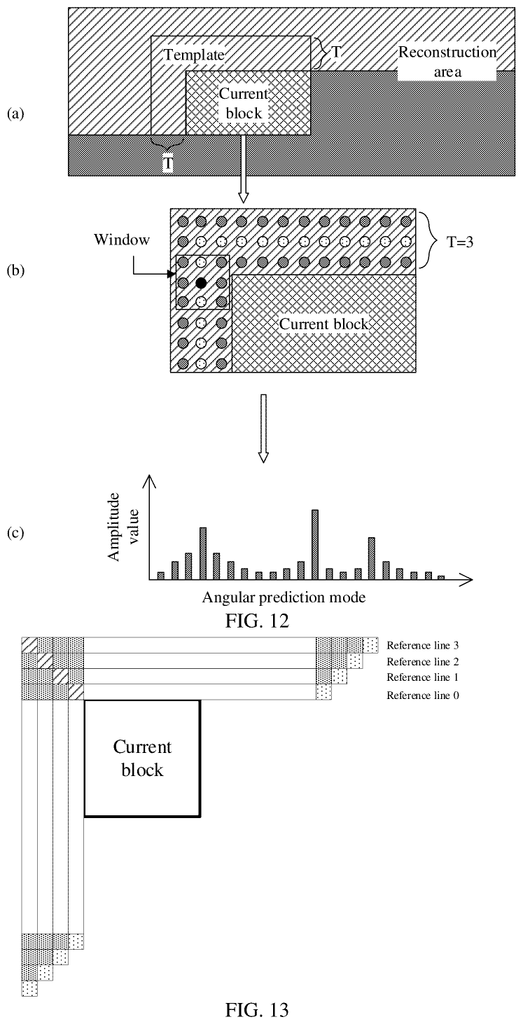

In some embodiments, using pixel values of T rows and T columns (for example, Tis equal to 3) of a reconstructed area around the current block as a template, a schematic diagram of steps of decoder-side intra mode derivation (DIMD) deriving an intra prediction mode is shown in FIG. 12, including: (a) scanning and calculating a gradient in a horizontal direction and a gradient in a vertical direction on each 3×3 area of the template by using a sobel operator; (b) calculating an amplitude value Amp=Dx+Dy and an angle value angle=arctan (Dy/Dx) at each location according to the gradients Dx and Dy that are obtained in the horizontal and vertical directions. The angle at each location of the template is matched to a conventional angular prediction mode. By sliding a window in (b), multiple amplitude values of neighboring reconstructed parts and corresponding angle values are obtained, and amplitude values corresponding to the same angular prediction mode is accumulated to obtain a histogram of the amplitude values and the angular prediction modes; and (c) selecting one or more angular prediction modes by sorting the amplitude values in a descending order. The one or more angular prediction modes are modes derived by the DIMD. It should be noted that when no angular prediction mode is derived from neighboring reconstructed values, the prediction mode derived by DIMD is set to the Planar prediction mode. When one or more angular prediction modes are derived, the prediction mode derived by DIMD is set to a weighted mode of the Planar mode and the one or more angular prediction modes.

In this embodiment of this application, when the prediction block at the current position is an intra prediction block, and DIMD is selected for the prediction block, at least three prediction modes derived by the DIMD may be determined as candidate prediction modes corresponding to the prediction block at the current position.

It should be noted that in this embodiment of this application, in a case in which the angular prediction modes derived by the TIMD and the DIMD is inconsistent with a preset angle precision corresponding to the first intra prediction flag, for example, is different from a preset angle precision corresponding to the angular prediction mode derived by the TMRL or the MPM technology, the angular prediction modes derived by the TIMD and the DIMD need to be matched to the preset angle precision corresponding to the first intra prediction flag, and the matched angular prediction modes are determined as candidate angular prediction modes, to fill the candidate intra prediction mode list.

In some embodiments, a process of the S1023 of determining the at least one candidate prediction mode based on the prediction mode of the prediction block at the current position may be implemented by S06-S07 as follows.

S06. In a case that the prediction block at the current position is an intra prediction block, and the prediction mode of the prediction block at the current position is a matrix weighted intra prediction mode or an intra template matching prediction mode, derive, by the decoder-side intra mode derivation mode, at least one prediction mode based on the prediction block at the current position.

In this embodiment of this application, when a prediction block at a current position is an intra prediction block, and a prediction mode of the prediction block is a matrix weighted intra prediction mode (MIP) or an intra template matching prediction mode (intra TMP), the DIMD is used to derive an intra prediction mode for the prediction block, and the intra prediction mode derived by the DIMD is used as a candidate prediction mode to fill the candidate intra prediction mode list.

S07. Determine the at least one candidate prediction mode according to the at least one prediction mode derived for the prediction block at the current position.

In this embodiment of this application, the decoder derives the at least one prediction mode of the current prediction block based on the foregoing S01-S06 process, and determines it as the at least one candidate prediction mode.

In some embodiments, in a case in which the quantity of candidate prediction modes determined according to the prediction modes of the prediction blocks in all of the at least five positions does not reach M, the decoder may perform extension on each angular prediction mode in the determined candidate prediction modes, and determine an angular prediction mode obtained by the extension as a candidate prediction mode. For example, angular prediction mode 18 is determined by using S01-S06 as a candidate prediction mode, and angular prediction mode 17, angular prediction mode 19, or the like may also be determined as a candidate prediction mode.

In some embodiments, if a quantity of candidate modes determined after performing the extension on each angular prediction mode still does not reach M, a preset angular prediction mode in a preset angular prediction mode set is determined as a candidate prediction mode until the M candidate prediction modes are determined.

In some embodiments, the M candidate prediction modes include no duplicate candidate prediction modes. That is, if a prediction mode is determined as a candidate prediction mode, that is, is added to the candidate prediction mode list, in a subsequent process of filling the candidate prediction mode list, the prediction mode will not be added to the candidate prediction mode list again. That is, the M candidate prediction modes are unique one to another.

For example, if the quantity of all candidate prediction modes determined for the prediction blocks in the at least five positions is less than M, the decoder may perform extension on the currently determined candidate prediction modes. For example, prediction modes obtained by performing +1 and/or −1 on each of the determined candidate prediction modes are determined as candidate prediction modes. If the quantity of candidate prediction modes still does not reach M, prediction modes obtained by performing +2 and/or −2 on each of the candidate prediction modes determined in S01-S06 are determined as candidate prediction modes. If the quantity of candidate prediction modes still does not reach M, prediction modes obtained by performing +3 and/or −3 on each of the candidate prediction modes determined in S01-S06 are determined as candidate prediction modes. If the quantity of candidate prediction modes still does not reach M, prediction modes obtained by performing +4 and/or −4 on each of the candidate prediction modes determined in S01-S06 are determined as candidate prediction modes. If the quantity of candidate prediction modes still does not reach M, a preset intra prediction mode in a preset intra prediction mode list, such as the preset intra prediction mode list mpm_default[20], is determined as a candidate prediction mode until M candidate prediction modes are determined.

For example, prediction blocks in five positions are used as an example. A process of the foregoing S1021-S1023 may be implemented as the following process.

When the first intra prediction flag is MPM, that is, when the current candidate prediction mode list to be filled is an MPM list, the decoder determines that M is 22, and fill the Planar mode is in the first position of the MPM list, and then remaining positions of the MPM list are filled in a sequence of step 1) to step 10), to determine the M candidate prediction modes. When the first intra prediction flag is TMRL, that is, when the current candidate prediction mode list to be filled is a TMRL candidate list, the Planar mode is not added to the intra candidate prediction mode list, and the TMRL candidate list is filled according to a sequence of step 1 to step 10 to determine the M candidate prediction modes. It should be noted that, when the candidate prediction mode list is filled by using step 1) to step 10), it needs to be determined whether a quantity of filled modes is less than or equal to M, and a currently determined candidate prediction mode is not a duplicated mode.

Step 1: Separately determine whether the left prediction block 0 and the upper prediction block 0 are intra prediction blocks; and if the prediction block is an intra prediction block, perform any one of step 1-1 to step 1-3:

Step 1-1: If the prediction mode selected for the prediction block is a conventional prediction mode, determine the conventional prediction mode selected by the prediction block as a candidate prediction mode.

Step 1-2: If the prediction mode selected for the prediction block is TIMD, the prediction mode derived by the TIMD is matched to a conventional prediction mode, and the matched conventional prediction mode is determined as a candidate prediction mode.

Step 1-3: If the prediction mode selected by the prediction block is the SGPM mode, match an angle used in SGPM partition to a conventional prediction mode, and determine the matched conventional prediction mode as a candidate prediction mode.

Step 2: Separately determine whether the left prediction block 0 and the upper prediction block 0 are inter prediction blocks; and if the prediction block is an inter prediction block, and a prediction mode selected for the prediction block is GPM, match an angle used in GPM partition to a conventional prediction mode, and determine the matched conventional prediction mode as a candidate prediction mode; otherwise determine the intra prediction mode transferred to the prediction block as a candidate prediction mode.

Step 3: Separately determine whether the above left prediction block, the above right prediction block, and the below left prediction block are intra prediction blocks; and if the prediction block is an intra prediction block, perform any one of any one of step 3-1 to step 3-3:

Step 3-1: If a prediction mode selected for the prediction block is a conventional prediction mode, determine the conventional prediction mode selected for the prediction block as a candidate prediction mode.

Step 3-2: If the prediction mode selected for the prediction block is TIMD, match a prediction mode derived by the TIMD to a conventional prediction mode, and determine the matched conventional prediction mode as a candidate prediction mode.

Step 3-3: If the prediction mode selected by the prediction block is the SGPM mode, match an angle used in SGPM partition to a conventional prediction mode, and determine the matched conventional prediction mode as a candidate prediction mode.

Step 4: Separately determine whether the above left prediction block, the above right prediction block, and the below left prediction block are intra prediction blocks; and if the prediction block uses the GPM mode, match an angle used in GPM partition to a conventional prediction mode, and determine the matched conventional prediction mode as a candidate prediction mode; otherwise, determine the intra prediction mode transferred to the prediction block as a candidate prediction mode.

Step 5: If a prediction mode with a largest gradient value derived by the DIMD exists, determine the prediction mode as a candidate prediction mode; if a prediction mode with a second largest gradient value derived by the DIMD exists, determine the prediction mode as a candidate prediction mode; and determine the DC mode as a candidate prediction mode.

Step 6: Extend angular prediction modes obtained in step 1) to step 5) one by one by performing +1 and −1, to be determined as candidate prediction modes. If the quantity of candidate prediction modes is less than M, step 7) is performed.

Step 7: Extend angular prediction modes obtained in step (1) to step (5) one by one by performing +2 and −2, to be determined as candidate prediction modes. If the quantity of candidate prediction modes is less than M, step 8) is performed.

Step 8: Expand the angular prediction modes obtained in step (1) to step (5) one by one by performing +3 and −3, to be determined as candidate prediction modes. If the quantity of candidate prediction modes is less than M, step 9) is performed.

Step 9: Expand the angular prediction modes obtained in step (1) to step (5) one by one by performing +4, −4, to be determined as candidate prediction modes. If the quantity of candidate prediction modes is less than M, step 10) is performed.

Step 10: Determine one or more prediction modes in a preset intra prediction mode list as a candidate prediction mode until a quantity of candidate prediction modes reaches M.

It may be understood that, in the current related technology, if a surrounding prediction block of the current block uses a non-conventional prediction mode, such as MIP, intra TMP, GPM, and SGPM, the candidate prediction mode list of the MPM or the TMRL is filled directly by the Planar mode. In this embodiment of this application, the MIP, the intraTMP, the GPM, and the SGPM may be converted into corresponding angular prediction mode, thereby improving accuracy of a candidate prediction mode. In addition, in a current ECM, only an intra prediction mode with a least cost value derived by the TIMD is used as a candidate prediction mode, and in this embodiment of this application, an intra prediction mode with a second least cost value derived by the TIMD and an intra prediction mode with a horizontal direction and a vertical direction may also be used as candidate prediction modes, thereby extending a range of the candidate prediction modes, thereby improving prediction accuracy. In addition, in a current ECM, at most two intra prediction modes derived by the DIMD are used as candidate prediction modes. In this embodiment of this application, at least three of the at most five intra prediction modes derived by the DIMD may be used as candidate prediction modes, thereby extending a range of the candidate prediction modes, thereby improving prediction accuracy.

S103. Construct an intra prediction mode list based on the M candidate prediction modes, and perform intra prediction and picture reconstruction on the current block based on the intra prediction mode list to determine a reconstructed picture block corresponding to the current block.

In this embodiment of this application, the decoder may construct an intra prediction mode list based on the M candidate prediction modes, for example, an MPM list or a TMRL list, determine, based on the intra prediction mode list, an intra prediction mode suitable for the current block, and perform intra prediction and picture reconstruction on the current block by using the intra prediction mode, to determine a corresponding reconstructed picture block.

In some embodiments, the intra prediction mode list may be an MPM list, and the decoder may perform, by using the MPM list and the MRL technology, intra prediction and picture reconstruction on the current block to determine the reconstructed picture block corresponding to the current block. Herein, in addition to using the nearest row of reference pixels Reference line 0 (reference line 0), the MRL intra prediction technology may further use Reference line 1 (reference line 1) and Reference line 2 (reference line 2) as extended reference lines for intra prediction, as shown in FIG. 13. In some embodiments, to reduce coding complexity, MRL may be used only for a non-Planar mode in MPM.

In the ECM-6.0 reference software, the MRL tool can use more reference lines. When the multiple-reference-line prediction mode is used, Reference lines 1, 3, 5, 7 and 12 may be combined with the intra mode of the non-Planar mode of the MPM in addition to Reference line 0. In addition, when the TIMD mode is selected, Reference lines 1 and 3 in addition to Reference line 0 may also be allowed. The decoder performs combined prediction by using the candidate prediction modes in the MPM list and the foregoing reference lines, determines a combination of a prediction mode with a least cost value and a reference line according to prediction results of all combinations of the prediction modes and the reference lines, and performs prediction and reconstruction on the current block by using the combination to determine the reconstructed picture block corresponding to the current block.

In some embodiments, the intra prediction mode list may be a TMRL list. When the decoder determines, by parsing the bitstream, that TMRL is selected for the current block, the decoder further parses a list index of the TMRL from the bitstream. In the prediction and reconstruction of the current block, the TMRL list is constructed according to the M candidate prediction modes.

In some embodiments, a TMRL candidate list with a length of 10 may be constructed according to six (M=6) candidate prediction modes. The decoder may perform addition and/or subtraction by 1 on each angular prediction mode in the six candidate prediction modes without repetition to obtain new TMRL candidate prediction modes to fill the TMRL candidate list until ten TMRL candidate prediction modes are determined, that is, the TMRL list is fully filled, as shown in Table 2.

TABLE 2

| | |
|---|---|
| numCands = modeIdx | Recode a quantity of angular prediction |
| | modes in the M candidate prediction |
| | modes |
| if(numCands > 0 && !(numCands == 1 && mpm[0] | If there are more than 0 angular prediction |
| == DC_IDX)){ | mode, +1/−1 on the angular prediction |
| | mode is further attempted. Otherwise, +/−1 |
| | on the angular prediction mode is not |
| | performed. |
| for(i = 0; i < numCands && modeIdx < | |
| MPM_SIZE; i++){ | |
| if(mpm[i] <= DC_IDX) | If the candidate prediction mode is not an |
| | angular prediction mode, +/−1 does not |
| | need to be performed, and directly skip the |
| | candidate prediction mode. |
| continue | |
| mpm[modeIdx] = ((mpm[i] + offset) % mod) + | If (the i-th angular prediction mode −1) is |
| 2 | smaller than angular prediction mode 2, an |
| | angular prediction mode opposite to an |
| | angle of (the i-th angular prediction |
| | mode −1) is selected. |
| if(isInclude(mpm[modeIdx])) | |
| isInclude(mpm[modeIdx++]) = true | If (the angular prediction mode −1) is not a |
| | duplicated mode, it is filled in the TMRL |
| | list and a duplicate list is updated. |
| if(modeIdx >= MPM_SIZE) | If the quantity of TMRL candidate |
| | prediction modes reaches 10, stop. |
| break | |
| mpm[modeIdx] = ((mpm[i] −1) % mod) + 2 | If (the i-th angular prediction mode +1) is |
| | larger than angular prediction mode 66, an |
| | angular prediction mode opposite to an |
| | angle of (the i-th angular prediction mode −1) |
| | is selected. |
| if(isInclude(mpm[modeIdx])) | |
| isInclude(mpm[modeIdx++]) = true | If angular prediction mode +1 is not a |
| | duplicated mode, it is filled in the TMRL |
| | list and a duplicate list is updated. |
| } | |
| } | |
| ... ... | If the foregoing process still does not |
| | fill up the TMRL list, a preset TMRL intra |
| | prediction mode is used to fill the TMRL |
| | list. |

In some embodiments, the preset TMRL intra prediction modes are multiple angular prediction modes selected according to a statistical rule. For example, the method may include: {DC_IDX, VER_IDX, HOR_IDX, VER_IDX−4, VER_IDX+4, 14, 22, 42, 58, 10, 26, 38, 62, 6, 30, 34, 66, 2, 48, 52, 16}. DC_IDX represents a DC mode, VER_IDX represents a vertical mode, HOR_IDX represents a horizontal mode, and other numbers represent angular prediction modes corresponding to the numbers.

It should be noted that, to control complexity and performance, a length of the TMRL candidate list may be set to 10, or may be set to a larger quantity of angular prediction modes for performance, or may be set to a smaller quantity of modes for reducing complexity. Specific implementations are selected according to actual situations, which is not limited in this embodiment of this application.

It should be noted that, according to experimental statistics, the PLANAR and DC modes being used together with the MRL technology shows no significant effect. Therefore, when determining the candidate prediction modes in the MPM list or the TMRL list, the Planar mode and the DC mode may be excluded. Alternatively, the two modes may not be excluded if not considering complexity. Specific implementations are selected according to actual situations, which is not limited in this embodiment of this application.

In some embodiments, for the TMRL technology, the decoder may determine the reference line corresponding to the current block according to the location of the current block in the picture. In some embodiments, the reference line corresponding to the current block may include an extended reference line list of the TMRL. It should be noted that the upper reference line corresponding to the current block should not exceed the upper CTU boundary corresponding to the current block. In ECM, the CTU may be extended to a maximum of 256×256. In this way, the horizontal coordinate x of the upper left corner of the current block in the picture is used to obtain a reminder over 256, and the obtained remainder is used as the quantity of above reference lines within the CTU boundary.

In some embodiments, among the reference line 1, reference line 3, reference line 5, reference line 7, and reference line 12 extended in the ECM, a reference line that is equal to or less than allowedMax may be used as the reference line corresponding to the current block. The allowedMax may be determined by using formula (1), as follows:

$$allowed Max = max ( 1 , min ( 12 , ( x \% 256 ) - 1 ) ) \qquad ( 1 )$$

In some embodiments, to obtain better decoding performance, or to reduce complexity, more or less reference lines may be used. Specific implementations are selected according to actual situations, which is not limited in this embodiment of this application.

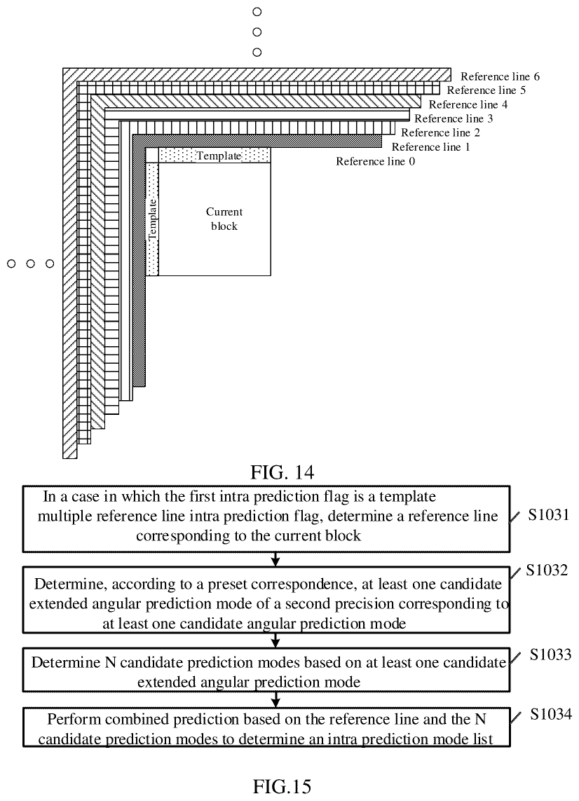

In some embodiments, the decoder combines each prediction mode in the TMRL candidate list and each reference line, performs prediction by using these combinations on the template of the row in which the reference line 0 is located as shown in FIG. 14, and performs 4 or 6 tap filtering on the reference line and the prediction result. In some embodiments, because the TMRL needs to obtain the prediction results on the template for multiple combinations, some of original filtering steps may be omitted or a filter of a shorter tap may be used. For example, when generating a prediction value on a template, filtering on used reference line pixels is not performed, but 4-tap interpolation filtering of 1/32 precision is performed on the generated prediction value at a non-integer angle. The decoder determines a corresponding filter coefficient to predict and reconstruct a template area according to each combination of an angular prediction mode and a reference line, determines a cost value between a prediction result and a reconstruction result on the template, and selects multiple combinations with small cost values to form the TMRL list. For example, 12 combinations with small cost values may be selected as the TMRL list.

In some embodiments, the decoder determines, in the TMRL list by using the list index of the TMRL obtained by parsing the bitstream, a combination of the reference line and the prediction mode that is specified by the list index, and predicts and reconstructs the current block according to the combination to obtain the reconstructed picture block corresponding to the current block.

It may be understood that, in this embodiment of this application, when the decoder performs decoding on the current block, for the first intra prediction mode selected for the current block, M candidate prediction modes corresponding to the first intra prediction mode may be determined based on prediction modes corresponding to at least five prediction blocks in positions neighboring to the current block. Therefore, for various intra prediction modes, the prediction mode list is subsequently constructed by using a unified method. Then, intra prediction and picture reconstruction may be performed on the current block based on the M candidate prediction modes, to determine a reconstructed picture block corresponding to the current block. In this way, decoding complexity is reduced, and decoding efficiency is improved, thereby improving decoding performance.

In some embodiments, the M candidate prediction modes include at least one candidate angular prediction mode of first precision. Based on FIG. 5, as shown in FIG. 15, in S103, the building of the intra prediction mode list based on the M candidate prediction modes may be implemented by the S1031-S1034 as follows.

S1031. In a case in which the first intra prediction flag is a template-based multiple reference line intra prediction flag, determine a reference line corresponding to the current block.

Here, the decoder may determine whether the TMRL is applicable to the current block by parsing the template-based multiple reference line intra prediction (TMRL) flag in the bitstream. In some embodiments, the TMRL flag may include one or more of a general constraint information syntax (general constraints information syntax, GCI), a sequence level flag, picture a picture level flag, a slice level flag, a coding block level flag. In a case in which the first intra prediction flag is a template-based multiple reference line intra prediction flag, it indicates that the current block selects the TMRL, and the decoder determines the reference line corresponding to the current block, so as to perform intra prediction based on the reference line. A process of determining the reference line corresponding to the current block by the decoder is similar to a process of determining the extended reference line of the TMRL in S103, and details are not described herein again.

S1032. Determine, according to a preset correspondence, at least one candidate extended angular prediction mode of a second precision corresponding to at least one candidate angular prediction mode.

In this embodiment of this application, the second precision is higher than the first precision. The decoder may match the at least one candidate angular prediction mode of the first precision to the at least one candidate extended angular prediction mode of the second precision according to a preset correspondence, so as to improve precision of the TMRL candidate prediction mode.

In some embodiments, the preset correspondence includes a preset correspondence between T preset angular prediction modes and T extended angular prediction modes in (2T−1) preset extended angular prediction modes. The (2T−1) extended angular prediction modes are obtained by obtaining one angular prediction mode between every two adjacent angular prediction modes of the T angular prediction modes, where T is a positive integer greater than 1.

In some embodiments, the TMRL does not need the angular prediction mode identified by a coded syntax element flag, but selects an angular prediction mode in a template matching manner. Therefore, the TMRL has a precision twice as the conventional angular mode, or a much higher precision than the conventional angular mode may be actually used, for example, three times of precision and four times of precision. Specific implementations are selected according to actual situations, which is not limited in this embodiment of this application.

For example, the first precision may be an angle precision in VVC. In VVC, the conventional angle prediction has 65 angles, and the corresponding intra prediction mode indexes are 2˜66 (as shown as ipm in FIG. 16). The angular prediction mode in the TMRL is obtained by derivation, needing no extra flag overhead for indication. Therefore, a better decoding effect can be obtained by using a finer angle.

In this embodiment of this application, a more precise angle may be added between two conventional angles, to obtain a total of 129 extended angles, with corresponding intra prediction mode indexes 2˜130 (as shown as ipmExt in FIG. 16). The ipm and ipmExt being equal to 0 and 1 respectively represent the Planar mode and the DC mode.

In some embodiments, matching of the candidate angular prediction mode ipm to the extended candidate angular prediction mode ipmExt may be performed by using the formula (2), as follows:

$$ipmExt = ipm < 2 ? ipm : ( ipm * 2 ) - 2 \qquad ( 2 )$$

In formula (2), ipm <2 indicates that the candidate angular prediction mode ipm is the Planar mode and the DC mode, and precision matching of the angular prediction mode does not need to be performed. If ipm <2 is not established, it indicates that the candidate angular prediction mode ipm is an angular prediction mode, and the part ipmExt=(ipm*2)−2 in formula (2) may be executed to determine an extended candidate angular prediction mode corresponding to the candidate angular prediction mode ipm.

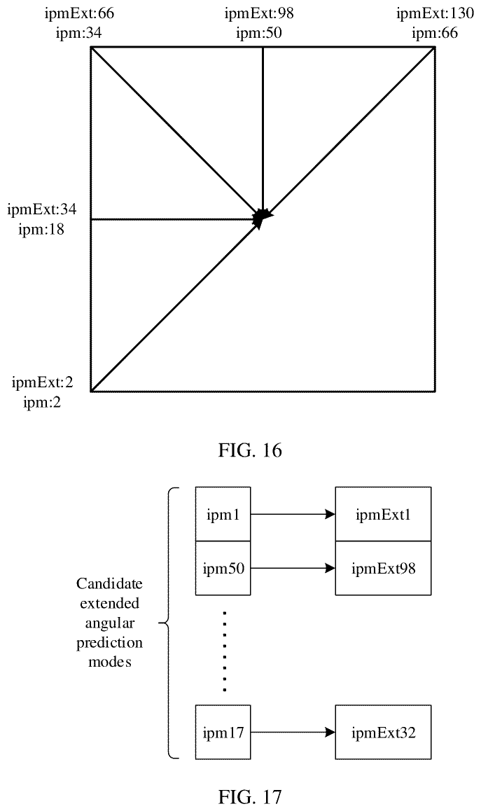

In some embodiments, a process of matching the 67 traditional intra prediction modes to the 131 prediction modes in this embodiment of this application may be as shown in FIG. 17.

In some embodiments, correspondingly, matching between the extended candidate angular prediction mode ipmExt and the candidate angular prediction mode ipm may be performed by using the formula (3) as follows:

$$ipm = ipmExt < 2 ? ipmExt : ( ipmExt / 2 ) + 1 \qquad ( 3 )$$

S1033. Determine N candidate prediction modes based on at least one candidate extended angular prediction mode.

In this embodiment of this application, N is a positive integer greater than or equal to M. The decoder may determine M candidate prediction modes that include at least one candidate extended angular prediction mode obtained by means of precision matching as N candidate prediction modes, and in this case, N is equal to M. Alternatively, the decoder may perform addition or subtraction on angular prediction modes in M candidate prediction modes that include the at least one candidate extended angular prediction mode obtained by means of precision matching to extend the angular prediction modes, and performs, according to a determined template area and the first reference line corresponding to the current block, prediction based on combinations of respective candidate extended angular prediction modes in multiple candidate extended angular prediction modes and the first reference line, and determines N candidate prediction modes according to prediction results.

In some embodiments, the decoder may perform angular prediction mode extension based on the at least one candidate extended angular prediction mode to determine a plurality of candidate extended angular prediction modes including the at least one candidate extended angular prediction mode.

In some embodiments, for each candidate extended angular prediction mode in the at least one candidate extended angular prediction mode, the decoder may determine at least one candidate extended angular prediction mode among at least one candidate extended angular prediction mode that is adjacent to the candidate extended angular prediction mode in preset extended angular prediction modes, so as to determine multiple candidate extended angular prediction modes.

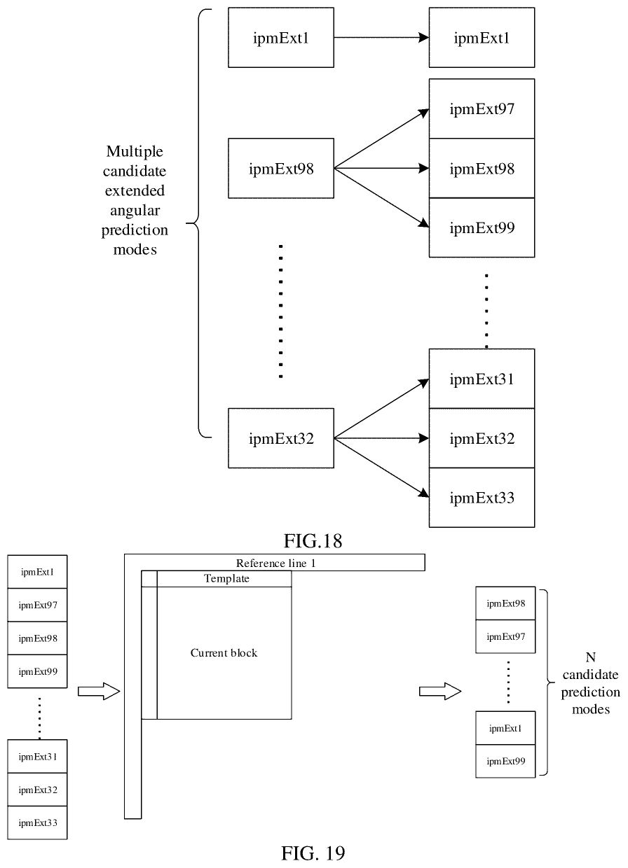

In some embodiments, the decoder determines, for each candidate extended angular prediction mode, at least one initial extended angular prediction mode adjacent to the candidate extended angular prediction mode in the preset extended angular prediction modes; and determines a non-duplicated initial extended angular prediction mode in the at least one initial extended angular prediction mode as the candidate extended angular prediction mode. For example, a process that the decoder performs precision extension on each candidate extended angular prediction mode ipmExt without duplication may be as shown in FIG. 18.

In some embodiments, based on the extended finer angular prediction mode, the decoder performs prediction on the template area by using an extended reference line, to select the N prediction modes with the lowest costs as the N candidate prediction modes, as shown in FIG. 19.

S1034. Perform combined prediction based on the reference line and the N candidate prediction modes to determine an intra prediction mode list.

In this embodiment of this application, the decoder combines the N candidate prediction modes respectively with another extended reference line, performs prediction in a template area and calculates costs, compares the costs with the stored costs obtained by combining the N candidate prediction modes respectively with the extended reference line 1, and selects K combinations of an intra prediction mode and an extended reference line according to an ascending order of the costs, to be used as the intra prediction mode list, that is, the TMRL list.

In some embodiments, K may be set to 20. This indicates that the length of the TMRL list is 20. Therefore, for the improved TMRL, the coding of the TMRL list index is not changed.

It should be noted that, when angle prediction is performed on the template area of the TMRL, because in this embodiment of this application, the angular prediction modes are extended from 65 to 129, an interpolation filter with the 1/64 position precision should be used to perform prediction interpolation on pixels that are located at sub-pixel positions under the angular mode.

It may be understood that, in this embodiment of this application, precision is improved on the angular prediction mode in the TMRL list, and a quantity of modes is extended based on the angular prediction mode with improved precision in the TMRL list, thereby improving accuracy of performing intra prediction based on the TMRL list, and thus improving decoding accuracy and decoding performance.

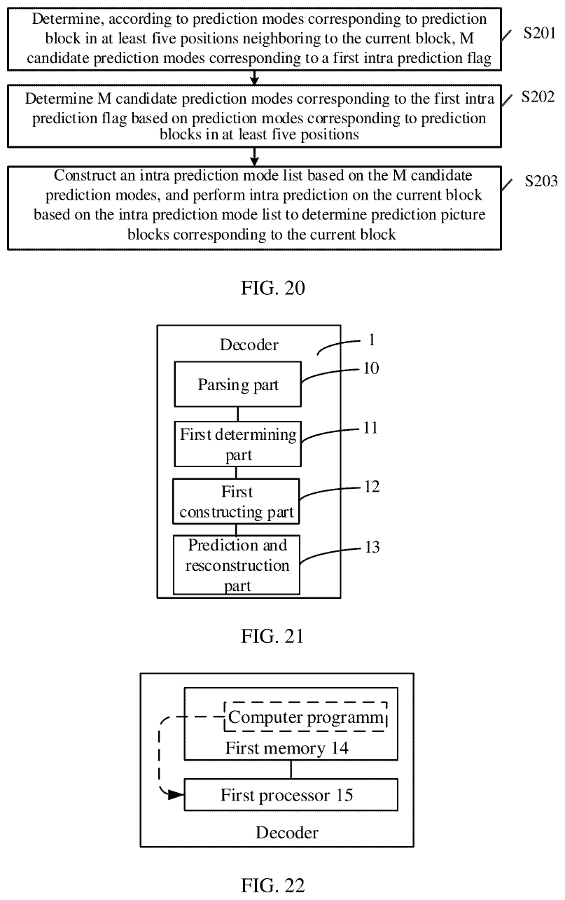

In an embodiment of this application, referring to FIG. 20, FIG. 20 shows a schematic flowchart of an encoding method according to an embodiment of this application. The method may include the following steps:

S201. Determine, according to prediction modes corresponding to prediction block in at least five positions neighboring to the current block, M candidate prediction modes corresponding to a first intra prediction flag.

In this embodiment of this application, when performing intra prediction on the current block, the encoder may predict the current block by using at least one intra prediction technology, calculate a corresponding cost value according to a prediction result corresponding to a respective intra prediction technology, for example, a rate distortion cost, and determine, according to the cost value, the intra prediction technology used for the current coding block. Herein, when the encoder performs intra prediction on the current block by using the intra prediction technology represented by the first intra prediction flag, M candidate prediction modes corresponding to the first intra prediction flag may be determined according to prediction modes corresponding to prediction blocks in at least five positions neighboring to the current block, to construct intra prediction mode list and perform intra prediction based on the M candidate prediction modes.

The first intra prediction flag may include any one of a template-based multiple reference line intra prediction flag (TMRL), a most probable mode flag (MPM), and a template-based intra mode derivation flag (TIMD).

A process of predicting the block in the at least five positions neighboring to the current block in S201 is consistent with a described process of S102 on the decoder side, and details are not described herein again.

S202. Determine M candidate prediction modes corresponding to the first intra prediction flag based on prediction modes corresponding to prediction blocks in at least five positions.

In S202, M is a positive integer, and a process of S202 is consistent with a described process of S103 on the decoder side. Details are not described herein again.

S203. Construct an intra prediction mode list based on the M candidate prediction modes, and perform intra prediction on the current block based on the intra prediction mode list to determine prediction picture blocks corresponding to the current block.

In S203, the intra prediction mode list is constructed based on the M candidate prediction modes, and a process of performing intra prediction on the current block based on the intra prediction mode list is consistent with a described process in S103 on the decoder side. Details are not described herein again. The encoder determines, according to the intra prediction result, a prediction picture block corresponding to the current block.

It may be understood that the encoder may determine the M candidate prediction modes corresponding to the first intra prediction mode based on the prediction modes corresponding to prediction blocks in the at least five positions neighboring to the current block. In this way, for various intra prediction modes, a prediction mode list is constructed by using a unified method. Therefore, intra prediction may be performed on the current block based on the M candidate prediction modes, to determine a prediction picture block corresponding to the current block. In this way, encoding complexity is reduced, and encoding efficiency is improved, thereby improving encoding performance.

In some embodiments, the encoder may calculate a cost value according to an error between the current block and the prediction picture block, and determine an optimal first prediction mode from the M candidate prediction modes. The encoder encodes the current block by using the first prediction mode, writes an encoded bit and the first intra prediction flag into a bitstream, and sends the bitstream to the decoder.

In some embodiments, the determining the prediction blocks in the at least five positions neighboring to the current block by the encoder includes: determining prediction blocks in seven positions neighboring to the current block; or determining prediction blocks in nine positions neighboring to the current block; or determining prediction blocks in all positions neighboring to the current block; or determining an adjacent prediction block or a non-adjacent prediction block corresponding to the current block as the prediction blocks.

In some embodiments, the determining the M candidate prediction modes corresponding to the first intra prediction flag according to the prediction modes corresponding to the prediction blocks in the at least five positions neighboring to the current block by the encoder comprises: determining a value of M according to the first intra prediction flag; determining a current position in the at least five positions according to a preset position sequence; and determining at least one candidate prediction mode based on a prediction mode of a prediction block at the current position, until the M candidate prediction modes are determined based on all of the at least five positions.

In some embodiments, the determining the at least one candidate prediction mode based on the prediction mode of the prediction block at the current position by the encoder comprises: in a case that the prediction block at the current position is an intra prediction block, and the prediction mode of the prediction block at the current position is a spatial geometric partitioning mode, determining an angular prediction mode corresponding to a partitioning direction of the prediction block at the current position as the at least one candidate prediction mode.

In some embodiments, the determining the at least one candidate prediction mode based on the prediction mode of the prediction block at the current position by the encoder comprises: in a case that the prediction block at the current position is an intra prediction block, and the prediction mode of the prediction block at the current position is a spatial geometric partitioning mode, determining two intra prediction modes corresponding to two partitioning blocks corresponding to the prediction block at the current position as the at least one candidate prediction mode.

In some embodiments, the determining the at least one candidate prediction mode based on the prediction mode of the prediction block at the current position by the encoder comprises: in a case that the prediction block at the current position is an inter prediction block, and the prediction mode of the prediction block at the current position is a geometric partitioning mode, determining an angular prediction mode corresponding to a partitioning direction of the prediction block at the current position as the at least one candidate prediction mode.

In some embodiments, the determining the at least one candidate prediction mode based on the prediction mode of the prediction block at the current position by the encoder comprises: in a case that the prediction block at the current position is an inter prediction block, and the prediction mode of the prediction block at the current position is a geometric partitioning mode, determining two intra prediction modes corresponding to two partitioning blocks corresponding to the prediction block at the current position as the at least one candidate prediction mode.

In some embodiments, the determining the at least one candidate prediction mode based on the prediction mode of the prediction block at the current position by the encoder comprises: in a case that the prediction block at the current position is an intra prediction block, and the prediction mode of the prediction block at the current position is a template-based intra mode derivation mode, determining the at least one candidate prediction mode according to at least two prediction modes derived by the template-based intra prediction mode.

In some embodiments, the at least two prediction modes comprise at least two of following: an intra prediction mode with a least cost value, an intra prediction mode with a second least cost value, an intra prediction mode in a horizontal direction, and an intra prediction mode in a vertical direction.

In some embodiments, the determining the at least one candidate prediction mode based on the prediction mode of the prediction block at the current position by the encoder comprises: in a case that the prediction block at the current position is an intra prediction block, and the prediction mode of the prediction block at the current position is a decoder-side intra mode derivation mode, determining the at least one candidate prediction mode according to at least three prediction modes derived by the decoder-side intra mode derivation mode.

In some embodiments, the determining the at least one candidate prediction mode based on the prediction mode of the prediction block at the current position by the encoder comprises: in a case that the prediction block at the current position is an intra prediction block, and the prediction mode of the prediction block at the current position is a matrix weighted intra prediction mode or an intra template matching prediction mode, deriving at least one prediction mode based on the prediction block at the current position by a decoder-side intra mode derivation mode; and determining the at least one candidate prediction mode according to the at least one prediction mode derived based on the prediction block at the current position.

In some embodiments, in a case that a quantity of candidate prediction modes determined according to the prediction modes of the prediction blocks in all of the at least five positions does not reach M, performing extension on each angular prediction mode in the determined candidate prediction modes, and determining an angular prediction mode obtained by the extension as a candidate prediction mode; and in a case that a quantity of candidate prediction modes determined after performing the extension on each angular prediction mode still does not reach M, determining a preset angular prediction mode in a preset angular prediction mode set as a candidate prediction mode until the M candidate prediction modes are determined.

In some embodiments, the M candidate prediction modes comprise no duplicate candidate prediction modes.

In some embodiments, the M candidate prediction modes comprise at least one candidate angular prediction mode of a first precision, and the constructing the intra prediction mode list based on the M candidate prediction modes by the encoder comprises: in a case that the first intra prediction flag is a template-based multiple reference line intra prediction flag, determining a reference line corresponding to the current block; determining, according to a preset correspondence, at least one candidate extended angular prediction mode of a second precision corresponding to the at least one candidate angular prediction mode, wherein the second precision is higher than the first precision; determining N candidate prediction modes based on the at least one candidate extended angular prediction mode, wherein N is a positive integer greater than or equal to M; and performing combined prediction based on the reference line and the N candidate prediction modes, to determine the intra prediction mode list.

In some embodiments, the preset correspondence comprises a preset correspondence between T angular prediction modes and T extended angular prediction modes in (2T−1) preset extended angular prediction modes, wherein the (2T−1) extended angular prediction modes are obtained by obtaining one extended angular prediction mode between every two adjacent angular prediction modes of the T angular prediction modes, T is a positive integer greater than 1.

In some embodiments, the determining the N candidate prediction modes based on the at least one candidate extended angular prediction mode by the decoder comprises: performing angular prediction mode extension based on the at least one candidate extended angular prediction mode, to determine a plurality of candidate extended angular prediction modes comprising the at least one candidate extended angular prediction mode; determining a template area and a first reference line corresponding to the current block; and performing, for each of the plurality of candidate extended angular prediction modes, prediction in the template area based on a combination of the respective candidate extended angular prediction mode and the first reference line, and determining the N intra candidate prediction modes according to prediction results.

In some embodiments, the performing the angular prediction mode extension based on the at least one candidate extended angular prediction mode, to determine the plurality of candidate extended angular prediction modes comprising the at least one candidate extended angular prediction mode by the encoder comprises: for each candidate extended angular prediction mode in the at least one candidate extended angular prediction mode, determining at least one candidate extended angular prediction mode according to at least one extended angular prediction mode that is adjacent to the respective candidate extended angular prediction mode in preset extended angular prediction modes, to determine the plurality of candidate extended angular prediction mode.

In some embodiments, the determining the at least one candidate extended angular prediction mode according to the at least one extended angular prediction mode that is adjacent to the respective candidate extended angular prediction mode in the preset extended angular prediction modes by the encoder comprises: determining at least one initial extended angular prediction mode that is adjacent to the respective candidate extended angular prediction mode in the preset extended angular prediction modes; and determining a non-duplicated initial extended angular prediction mode in the at least one initial extended angular prediction mode as the candidate extended angular prediction mode.

The processing on the encoder side is the same as that on the decoder side, and details are not described herein again.

Based on the foregoing embodiments, as shown in FIG. 21, an embodiment of this application provides a decoder 1, including:
a parsing part 10, configured to parse a bitstream to determine a first intra prediction flag corresponding to a current block;
a first determining part 11, configured to determine, according to prediction modes corresponding to prediction blocks in at least five positions neighboring to the current block, M candidate prediction modes corresponding to the first intra prediction flag, wherein M is a positive integer;
a first constructing part 12, configured to construct an intra prediction mode list based on the M candidate prediction modes; and
a prediction and reconstruction part 13, configured to perform intra prediction and picture reconstruction on the current block based on the intra prediction mode list to determine a reconstructed picture block corresponding to the current block.

In some embodiments, the first determining part 11 is further configured to determine prediction blocks in seven positions neighboring to the current block; determine prediction blocks in seven positions neighboring to the current block; determine prediction blocks in seven positions neighboring to the current block; or determine an adjacent prediction block or a non-adjacent prediction block corresponding to the current block.

In some embodiments, the first determining part 11 is further configured to determine a value of M according to the first intra prediction flag; determine a current position in the at least five positions according to a preset position sequence; and determine at least one candidate prediction mode based on a prediction mode of a prediction block at the current position, until the M candidate prediction modes are determined based on all of the at least five positions.

In some embodiments, the first determining part 11 is further configured to: in a case that the prediction block at the current position is an intra prediction block, and the prediction mode of the prediction block at the current position is a spatial geometric partitioning mode, determine an angular prediction mode corresponding to a partitioning direction of the prediction block at the current position as the at least one candidate prediction mode.

In some embodiments, the first determining part 11 is further configured to: in a case that the prediction block at the current position is an intra prediction block, and the prediction mode of the prediction block at the current position is a spatial geometric partitioning mode, determine two intra prediction modes corresponding to two partitioning blocks corresponding to the prediction block at the current position as the at least one candidate prediction mode.

In some embodiments, the first determining part 11 is further configured to: in a case that the prediction block at the current position is an inter prediction block, and the prediction mode of the prediction block at the current position is a geometric partitioning mode, determine an angular prediction mode corresponding to a partitioning direction of the prediction block at the current position as the at least one candidate prediction mode.

In some embodiments, the first determining part 11 is further configured to: in a case that the prediction block at the current position is an inter prediction block, and the prediction mode of the prediction block at the current position is a geometric partitioning mode, determine two intra prediction modes corresponding to two partitioning blocks corresponding to the prediction block at the current position as the at least one candidate prediction mode.

In some embodiments, the first determining part 11 is further configured to: in a case that the prediction block at the current position is an intra prediction block, and the prediction mode of the prediction block at the current position is a template-based intra mode derivation mode, determine the at least one candidate prediction mode according to at least two prediction modes derived by the template-based intra prediction mode.

In some embodiments, the at least two prediction modes comprise at least two of following: an intra prediction mode with a least cost value, an intra prediction mode with a second least cost value, an intra prediction mode in a horizontal direction, and an intra prediction mode in a vertical direction.

In some embodiments, the first determining part 11 is further configured to: in a case that the prediction block at the current position is an intra prediction block, and the prediction mode of the prediction block at the current position is a decoder-side intra mode derivation mode, determine the at least one candidate prediction mode according to at least three prediction modes derived by the decoder-side intra mode derivation mode.

In some embodiments, the first determining part 11 is further configured to: in a case that the prediction block at the current position is an intra prediction block, and the prediction mode of the prediction block at the current position is a matrix weighted intra prediction mode or an intra template matching prediction mode, derive at least one prediction mode based on the prediction block at the current position by a decoder-side intra mode derivation mode; and determine the at least one candidate prediction mode according to the at least one prediction mode derived based on the prediction block at the current position.

In some embodiments, the first determining part 11 is further configured to: in a case that a quantity of candidate prediction modes determined according to the prediction modes of the prediction blocks in all of the at least five positions does not reach M, perform extension on each angular prediction mode in the determined candidate prediction modes, and determine an angular prediction mode obtained by the extension as a candidate prediction mode; and in a case that a quantity of candidate prediction modes determined after performing the extension on each angular prediction mode still does not reach M, determine a preset angular prediction mode in a preset angular prediction mode set as a candidate prediction mode until the M candidate prediction modes are determined.

In some embodiments, the M candidate prediction modes comprise no duplicate candidate prediction modes.

In some embodiments, the first intra prediction flag includes: one of a template-based multiple reference line intra prediction flag, a most probable mode flag, and a template-based intra mode derivation flag.

In some embodiments, the M candidate prediction modes comprise at least one candidate angular prediction mode of a first precision, and the first constructing part 12 is further configured to: in a case that the first intra prediction flag is a template-based multiple reference line intra prediction flag, determine a reference line corresponding to the current block; determine, according to a preset correspondence, at least one candidate extended angular prediction mode of a second precision corresponding to the at least one candidate angular prediction mode, wherein the second precision is higher than the first precision; determine N candidate prediction modes based on the at least one candidate extended angular prediction mode, wherein N is a positive integer greater than or equal to M; and perform combined prediction based on the reference line and the N candidate prediction modes, to determine the intra prediction mode list.

In some embodiments, the preset correspondence comprises a preset correspondence between T angular prediction modes and T extended angular prediction modes in (2T−1) preset extended angular prediction modes, wherein the (2T−1) extended angular prediction modes are obtained by obtaining one extended angular prediction mode between every two adjacent angular prediction modes of the T angular prediction modes, T is a positive integer greater than 1.

In some embodiments, the first constructing part 12 is further configured to perform angular prediction mode extension based on the at least one candidate extended angular prediction mode, to determine a plurality of candidate extended angular prediction modes comprising the at least one candidate extended angular prediction mode; determine a template area and a first reference line corresponding to the current block; and perform, for each of the plurality of candidate extended angular prediction modes, prediction in the template area based on a combination of the respective candidate extended angular prediction mode and the first reference line, and determine the N intra candidate prediction modes according to prediction results.

In some embodiments, the first constructing part 12 is further configured to: for each candidate extended angular prediction mode in the at least one candidate extended angular prediction mode, determine at least one candidate extended angular prediction mode according to at least one extended angular prediction mode that is adjacent to the respective candidate extended angular prediction mode in preset extended angular prediction modes, to determine the plurality of candidate extended angular prediction mode.

In some embodiments, the first constructing part 12 is further configured to determine at least one initial extended angular prediction mode that is adjacent to the respective candidate extended angular prediction mode in the preset extended angular prediction modes; and determine a non-duplicated initial extended angular prediction mode in the at least one initial extended angular prediction mode as the candidate extended angular prediction mode.

In an actual application of this application, as shown in FIG. 22, an embodiment of this application further provides a decoder, including: a first memory 14 and a first processor 15. The first memory 14 stores a computer program executable by the first processor 15. When executing the program, the first processor 15 implements the video decoding method provided in this embodiment of this application.

The first processor 15 may be implemented by using software, hardware, firmware, or a combination thereof, and may be implemented by using a circuit, an application specific integrated circuits (application specific integrated circuits, ASIC), a single or multiple general-purpose integrated circuits, a single or multiple microprocessors, a single or multiple programmable logic devices, a combination of the foregoing circuits or devices, or another suitable circuit or device, so that the first processor 15 may perform corresponding steps of the video decoding method provided in any embodiment of this application.

It should be noted that the foregoing description of the decoder embodiments is similar to the foregoing description of the method embodiments, and has a beneficial effect similar to that of the method embodiments. For technical details that are not disclosed in the decoder embodiment of the present invention, one may refer to the description of the method embodiments of the present invention.

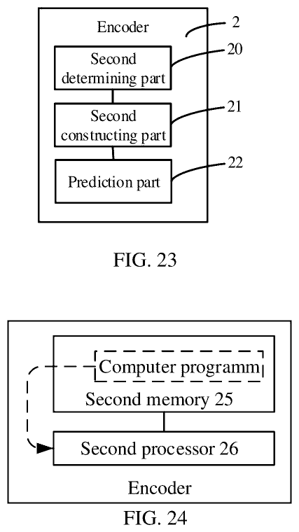

An embodiment of this application provides an encoder 2. As shown in FIG. 23, the encoder 2 includes:
a second determining part 20, configured to determine M candidate prediction modes corresponding to a first intra prediction flag according to prediction modes corresponding to prediction blocks in at least five positions neighboring to a current block, wherein M is a positive integer;
a second constructing part 21, configured to construct an intra prediction mode list based on the M candidate prediction modes; and
a prediction part 22, configured to: perform intra prediction on the current block based on the intra prediction mode list, to determine prediction picture blocks corresponding to the current block.

In some embodiments, the encoder 2 further includes an encoding part. The encode part is configured to determine a first prediction mode from the M candidate prediction modes according to the current block and the prediction picture blocks; and encode the current block by using the first prediction mode, and writing an encoded bit and the first intra prediction flag into a bitstream.

In some embodiments, the second determining part 20 is further configured to determine prediction blocks in seven positions neighboring to the current block; or determine prediction blocks in nine positions neighboring to the current block; or determine prediction blocks in all positions neighboring to the current block; or determine an adjacent prediction block or a non-adjacent prediction block corresponding to the current block as the prediction blocks.

In some embodiments, the second determining part 21 is further configured to determine a value of M according to the first intra prediction flag; determine a current position in the at least five positions according to a preset position sequence; and determine at least one candidate prediction mode based on a prediction mode of a prediction block at the current position, until the M candidate prediction modes are determined based on all of the at least five positions.

In some embodiments, the second determining part 20 is further configured to: in a case that the prediction block at the current position is an intra prediction block, and the prediction mode of the prediction block at the current position is a spatial geometric partitioning mode, determine an angular prediction mode corresponding to a partitioning direction of the prediction block at the current position as the at least one candidate prediction mode.

In some embodiments, the second determining part 20 is further configured to: in a case that the prediction block at the current position is an intra prediction block, and the prediction mode of the prediction block at the current position is a spatial geometric partitioning mode, determine two intra prediction modes corresponding to two partitioning blocks corresponding to the prediction block at the current position as the at least one candidate prediction mode.

In some embodiments, the second determining part 20 is further configured to: in a case that the prediction block at the current position is an inter prediction block, and the prediction mode of the prediction block at the current position is a geometric partitioning mode, determine an angular prediction mode corresponding to a partitioning direction of the prediction block at the current position as the at least one candidate prediction mode.

In some embodiments, the second determining part 20 is further configured to: in a case that the prediction block at the current position is an inter prediction block, and the prediction mode of the prediction block at the current position is a geometric partitioning mode, determine two intra prediction modes corresponding to two partitioning blocks corresponding to the prediction block at the current position as the at least one candidate prediction mode.

In some embodiments, the second determining part 20 is further configured to: in a case that the prediction block at the current position is an intra prediction block, and the prediction mode of the prediction block at the current position is a template-based intra mode derivation mode, determine the at least one candidate prediction mode according to at least two prediction modes derived by the template-based intra prediction mode.

In some embodiments, the at least two prediction modes include at least two of the following: an intra prediction mode with a least cost value, an intra prediction mode with a second least cost value, an intra prediction mode in a horizontal direction, and an intra prediction mode in a vertical direction.

In some embodiments, the second determining part 20 is further configured to: in a case that the prediction block at the current position is an intra prediction block, and the prediction mode of the prediction block at the current position is a decoder-side intra mode derivation mode, determine the at least one candidate prediction mode according to at least three prediction modes derived by the decoder-side intra mode derivation mode.

In some embodiments, the second determining part 20 is further configured to: in a case that the prediction block at the current position is an intra prediction block, and the prediction mode of the prediction block at the current position is a matrix weighted intra prediction mode or an intra template matching prediction mode, derive at least one prediction mode based on the prediction block at the current position by a decoder-side intra mode derivation mode; and determine the at least one candidate prediction mode according to the at least one prediction mode derived based on the prediction block at the current position.

In some embodiments, the second determining part 20 is further configured to: in a case that a quantity of candidate prediction modes determined according to the prediction modes of the prediction blocks in all of the at least five positions does not reach M, perform extension on each angular prediction mode in the determined candidate prediction modes, and determine an angular prediction mode obtained by the extension as a candidate prediction mode; and in a case that a quantity of candidate prediction modes determined after performing the extension on each angular prediction mode still does not reach M, determine a preset angular prediction mode in a preset angular prediction mode set as a candidate prediction mode until the M candidate prediction modes are determined.

In some embodiments, the M candidate prediction modes comprise no duplicate candidate prediction modes.

In some embodiments, the first intra prediction flag includes: one of a template-based multiple reference line intra prediction flag, a most probable mode flag, and a template-based intra mode derivation flag.

In some embodiments, the M candidate prediction modes comprise at least one candidate angular prediction mode of a first precision, and the second constructing part 22 is further configured to: in a case that the first intra prediction flag is a template-based multiple reference line intra prediction flag, determine a reference line corresponding to the current block; determine, according to a preset correspondence, at least one candidate extended angular prediction mode of a second precision corresponding to the at least one candidate angular prediction mode, wherein the second precision is higher than the first precision; determine N candidate prediction modes based on the at least one candidate extended angular prediction mode, wherein N is a positive integer greater than or equal to M; and perform combined prediction based on the reference line and the N candidate prediction modes, to determine the intra prediction mode list.

In some embodiments, the preset correspondence comprises a preset correspondence between T angular prediction modes and T extended angular prediction modes in (2T−1) preset extended angular prediction modes, wherein the (2T−1) extended angular prediction modes are obtained by obtaining one extended angular prediction mode between every two adjacent angular prediction modes of the T angular prediction modes, T is a positive integer greater than 1.

In some embodiments, the second constructing part 22 is further configured to perform angular prediction mode extension based on the at least one candidate extended angular prediction mode, to determine a plurality of candidate extended angular prediction modes comprising the at least one candidate extended angular prediction mode; determine a template area and a first reference line corresponding to the current block; and perform, for each of the plurality of candidate extended angular prediction modes, prediction in the template area based on a combination of the respective candidate extended angular prediction mode and the first reference line, and determine the N intra candidate prediction modes according to prediction results.

In some embodiments, the second constructing part 22 is further configured to: for each candidate extended angular prediction mode in the at least one candidate extended angular prediction mode, determine at least one candidate extended angular prediction mode according to at least one extended angular prediction mode that is adjacent to the respective candidate extended angular prediction mode in preset extended angular prediction modes, to determine the plurality of candidate extended angular prediction mode.

In some embodiments, the second constructing part 22 is further configured to determine at least one initial extended angular prediction mode that is adjacent to the respective candidate extended angular prediction mode in the preset extended angular prediction modes; and determine a non-duplicated initial extended angular prediction mode in the at least one initial extended angular prediction mode as the candidate extended angular prediction mode.

In an actual application, as shown in FIG. 24, an embodiment of this application further provides an encoder, including: a second memory 25 and a second processor 26. The second memory 25 stores a computer program executable by the second processor 26, and the second processor 26 implements the video encoding method provided in this embodiment of this application when executing the program.

It should be noted that the foregoing description of the encoder embodiments is similar to the foregoing description of the method embodiments, and has a beneficial effect similar to that of the method embodiments. For technical details that are not disclosed in the encoder embodiments of the present invention, one may refer to the description of the method embodiments of the present invention.

An embodiment of this application provides a bitstream, and the bitstream is generated by performing bit encoding according to to-be-encode information. The to-be-encode information includes: a first intra prediction flag and an encoded bit obtained by encoding a current block by a first prediction mode. The first prediction mode is determined in the following manner:
determining M candidate prediction modes corresponding to the first intra prediction flag according to prediction modes corresponding to prediction blocks in at least five positions neighboring to a current block, wherein M is a positive integer;
constructing an intra prediction mode list based on the M candidate prediction modes, and performing intra prediction on the current block based on the intra prediction mode list, to determine prediction picture blocks corresponding to the current block; and
determining the first prediction mode from the M candidate prediction modes according to the current block and the prediction picture blocks.

An embodiment of this application provides a computer readable storage medium, and a computer program is stored on the computer readable storage medium. When the computer program is executed by a first processor, a video decoding method provided in an embodiment of this application is implemented. Alternatively, when the computer program is executed by a second processor, a video encoding method provided in an embodiment of this application is implemented.

In this embodiment of this application, various components may be integrated into one processing unit, or each unit may exist alone physically, or two or more units may be integrated into one unit. The foregoing integrated unit may be implemented in a form of hardware, or may be implemented in a form of a software function module block.

If the integrated unit is implemented in a form of a software function module and is sold or used as an independent product, the integrated unit may be stored in a computer readable storage medium. Based on this understanding, the essential technical solution in embodiments, or the part contributing to the prior art, or all or a part of the technical solution may be implemented in a form of a software product. The computer software product is stored in a storage medium and includes several instructions for instructing a computer device (which may be a personal computer, a server, a network device, or the like) or a processor (processor) to perform all or a part of the steps of the methods in the embodiments. The foregoing computer readable storage medium includes any medium that can store program code, such as a magnetic random access memory (FRAM, ferromagnetic random access memory), a read-only memory (ROM, Read Only Memory), a programmable read-only memory (PROM, Programmable Read-Only Memory), an erasable programmable read-only memory (EPROM, Erasable Programmable Read-Only Memory), an electrically erasable programmable read-only memory (EEPROM, Electrically Erasable Programmable Read-Only Memory), a flash memory (Flash Memory), a magnetic surface memory, an optical disc, or a read-only optical disc (CD-ROM, Compact Disc Read-Only Memory). This is not limited in this embodiment of this disclosure.

The foregoing descriptions are merely some implementations of this application, but are not intended to limit the protection scope of this application. Any change or replacement readily figured out by a person skilled in the art within the technical scope disclosed in this application shall fall within the protection scope of this application. Therefore, the protection scope of this application shall be subject to the protection scope of the claims.

### INDUSTRIAL PRACTICALITY

Embodiments of this application provides a video encoding/decoding method, a decoder, an encoder, and a computer readable storage medium. When coding a current block, for a first intra prediction mode selected for the current block, M candidate prediction modes corresponding to the first intra prediction mode may be determined based on prediction modes corresponding to at least five prediction blocks in positions neighboring to the current block. In this way, for various intra prediction modes, the prediction mode list is subsequently constructed by using a unified method. Then, intra prediction may be performed on the current block based on the M candidate prediction modes. In this way, coding complexity is reduced, and coding efficiency is improved, thereby improving coding performance. Further, in some embodiments of this application, precision is improved for the angular prediction mode in the TMRL list, and a quantity of modes is extended based on the angular prediction mode with improved precision, thereby improving accuracy of performing intra prediction based on the TMRL list, and further improving decoding accuracy and decoding performance.

What is claimed is:

1. A video decoding method, comprising:
parsing a bitstream to determine a first intra prediction flag corresponding to a current block;
determining, according to prediction modes corresponding to one or more positions neighboring to the current block, M candidate prediction modes corresponding to the first intra prediction flag, wherein M is a positive integer;
constructing an intra prediction mode list based on the M candidate prediction modes, and performing intra prediction on the current block based on the intra prediction mode list, to determine a prediction block of the current block;
determining a reconstructed block of the current block based on the prediction block of the current block.

2. The method according to claim 1, wherein the one or more positions neighboring to the current block comprise:
seven positions neighboring to the current block; or
nine positions neighboring to the current block; or
all positions neighboring to the current block; or
an adjacent position or a non-adjacent position corresponding to the current block.

3. The method according to claim 1, the determining, according to prediction modes corresponding to one or more positions neighboring to the current block, M candidate prediction modes corresponding to the first intra prediction flag comprises:
determining at least one candidate prediction mode according a prediction mode corresponding to a current position, wherein the current position is one of the one or more positions.

4. The method according to claim 3, wherein the determining, according to the prediction modes corresponding to the one or more positions neighboring to the current block, the M candidate prediction modes corresponding to the first intra prediction flag comprises:
determining a value of M according to the first intra prediction flag;
determining the M candidate prediction modes according to prediction modes corresponding to all or part of the one or more positions neighboring to the current block, in a preset position sequence.

5. The method according to claim 3, wherein the determining the at least one candidate prediction mode according the prediction mode corresponding to the current position comprises:
in a case that the prediction mode corresponding to the current position is a spatial geometric partitioning mode, determining an angular prediction mode according to a partitioning direction of a prediction block including the current position, and determining the at least one candidate prediction mode according to the angular prediction mode.

6. The method according to claim 3, wherein the determining the at least one candidate prediction mode according the prediction mode corresponding to the current position comprises:
in a case that the prediction mode corresponding to the current position is a spatial geometric partitioning mode, determining the at least one candidate prediction mode according to two intra prediction modes corresponding to two partitioning blocks corresponding to a prediction block including the current position.

7. The method according to claim 3, wherein the determining the at least one candidate prediction mode according the prediction mode corresponding to the current position comprises:
in a case that the prediction mode corresponding to the current position is a geometric partitioning mode, determining an angular prediction mode according to a partitioning direction of a prediction block including the current position, and determining the at least one candidate prediction mode according to the angular prediction mode.

8. The method according to claim 3, wherein the determining the at least one candidate prediction mode according the prediction mode corresponding to the current position comprises:
in a case that the prediction mode corresponding to the current position is a geometric partitioning mode, determining the at least one candidate prediction mode according to two intra prediction modes corresponding to two partitioning blocks corresponding to a prediction block including the current position.

9. The method according to claim 3, wherein the determining the at least one candidate prediction mode according the prediction mode corresponding to the current position comprises:
in a case that the prediction mode corresponding to the current position is a template-based intra mode derivation mode, determining the at least one candidate prediction mode according to a prediction mode derived by the template-based intra prediction mode.

10. The method according to claim 3, wherein the determining the at least one candidate prediction mode according the prediction mode corresponding to the current position comprises:
in a case that the prediction mode corresponding to the current position is a decoder-side intra mode derivation mode, determining the at least one candidate prediction mode according to a prediction mode derived by the decoder-side intra mode derivation mode.

11. The method according to claim 3, wherein the method further comprises:
performing extension on an angular prediction mode in the determined candidate prediction modes, and determining a candidate prediction mode according to an angular prediction mode obtained by the extension.

12. The method according to claim 3, further comprising:
determining a candidate prediction mode according to a preset angular prediction mode in a preset angular prediction mode set.

13. The method according to claim 1, wherein
the M candidate prediction modes comprise no duplicate candidate prediction modes.

14. The method according to claim 1, wherein the first intra prediction flag comprises:
one of a template-based multiple reference line intra prediction flag, a most probable mode flag, and a template-based intra mode derivation flag.

15. The method according to claim 1, wherein the M candidate prediction modes comprise at least one candidate angular prediction mode of a first precision, and the constructing the intra prediction mode list based on the M candidate prediction modes comprises:
determining, according to a preset correspondence, at least one candidate extended angular prediction mode of a second precision corresponding to at least one candidate angular prediction mode of a first precision, wherein the second precision is higher than the first precision;
determining N candidate prediction modes based on the at least one candidate extended angular prediction mode; and
determining the intra prediction mode list according to the N candidate prediction modes.

16. The method according to claim 15, wherein
the preset correspondence comprises a correspondence between preset T angular prediction modes of the first precision and T extended angular prediction modes in preset (2T−1) preset extended angular prediction modes of the second precision, wherein the (2T−1) extended angular prediction modes are obtained by obtaining one extended angular prediction mode between every two adjacent angular prediction modes of the T angular prediction modes, T is a positive integer greater than 1.

17. The method according to claim 15, wherein the determining the N candidate prediction modes based on the at least one candidate extended angular prediction mode comprises:
determining an extended candidate extended angular prediction mode according to at least one candidate extended angular prediction mode;
determining the N intra candidate prediction modes according to the extended candidate extended angular prediction mode.

18. The method according to claim 15, wherein the determining the intra prediction mode list according to the N candidate prediction modes comprises:
determining a reference line corresponding to the current block;
performing prediction in a template area corresponding to the current block based on combinations of respective ones of the N candidate prediction modes and the reference line corresponding to the current block, and determining combinations of K respective candidate prediction modes and the reference line based on prediction results; and
determining the intra prediction mode list according to the combinations of the K respective candidate prediction modes and the reference line.

19. A video encoding method, comprising:
determining M candidate prediction modes corresponding to a first intra prediction flag according to prediction modes corresponding to one or more positions neighboring to a current block, wherein M is a positive integer;
constructing an intra prediction mode list based on the M candidate prediction modes, and performing intra prediction on the current block based on the intra prediction mode list, to determine a prediction block of the current block.

20. A non-transitory storage medium, storing a bitstream generated by:
determining M candidate prediction modes corresponding to a first intra prediction flag according to prediction modes corresponding to one or more positions neighboring to a current block, wherein M is a positive integer;
constructing an intra prediction mode list based on the M candidate prediction modes, and performing intra prediction on the current block based on the intra prediction mode list, to determine a prediction block of the current block.
